(19) United States
(12) Patent Application Publication
(10) Pub. No.: US 2010/0225667 A1
(43) Pub. Date: Sep. 9, 2010

(54) Content Display Method Content Display Device and Program

(75) Inventors: Kyosuke Nishiyama, Tokyo (JP); Shuji Senda, Tokyo (JP)

Correspondence Address: FOLEY AND LARDNER LLP;SUITE 500, 3000 K STREET NW, WASHINGTON, DC, 20007, US

(73) Assignee: NEC Corporation

(21) Appl. No.: 12/223,259

(22) PCT Filed: Jan. 30, 2007
(86) PCT No.: PCT/JP2007/051429

§ 371 Date: Jul. 25, 2008

(30) Foreign Application Priority Data
Jan. 31, 2006 (JP) 2006-021627
Jan. 26, 2007 (JP) 2007-017037

(51) Int. Cl. G06T 11/20; G09G 5/00

(52) U.S. Cl. 345/660; 345/441

(57) ABSTRACT

A thumbnail creating section creates a thumbnail of a specified object to be read. A linear information computing section computes an internal coordinate used as linear information from attribute information on each content. An order-of-priority determining section determines the order of priority of each content. A thumbnail line-forming section forms a line of thumbnails according to the scale specified by the user. A superposition thumbnail nondisplay section does not display a thumbnail having the lower order of priority than that of the other of the superposed thumbnails.

### APPLICABLE FIELD IN THE INDUSTRY

The present invention relates to a content display method, a content display device, and a program, and more particularly to a content display method, a content display device, and a program at the moment of displaying a plurality of contents on a display screen.

### BACKGROUND ART

Conventionally, for example, so as to retrieve images photographed with a digital camera, images prepared with image processing software, or the like, a so-called thumbnail display for reducing images, juxtaposing them in plural, and arranging them is made in some cases.

This conventional thumbnail display is for finding out a desired image from among the images, which are sequentially displayed, by simultaneously displaying a plurality of the thumbnails on one screen, and performing a key operation that is equivalent to turning over a page, or the like.

However, only juxtaposing and displaying a plurality of the images in a simple manner causes a problem that it takes much time to find out a desired image.

Conventionally, when an user picks up the image having a photographing date that he/her needs, he/her has no other way but finding out the desired image from among the images displayed in the order of photographing by turning over pages until the images photographed on its date are displayed or the like because it is merely in the order of photographing that the images are juxtaposed and displayed.

Thereupon, the technology has been provided of, when reducing a plurality of the images and displaying them on the screen, storing a plurality of the images together with times related to respective images, setting a time axis on the screen, arranging respective images near to positions on the time axis that correspond to the times added to respective images, and displaying each image according to the order and the time interval that correspond to the time (for example, Patent document 1).

This technology enables the time such as the broad photographing date of each image to be determined from the display position of each image that is displayed according to the order and the time interval along with the time axis on the screen.

Patent document 1: JP-P2004-328265A

### DISCLOSURE OF THE INVENTION

### Problems to be Solved by the Invention

By the way, there is the case that each of the contents including the image such as a picture has some priority. For example, in the case of the picture photographing, with the picture photographed skillfully, its picture image is given favorite attribution information in some cases, and its picture is particularly given a priority for some reason or other in some cases. In such a case, making a thumbnail display of these contents necessitates the display having a priority taken into consideration.

However, the technology of the Patent document 1, which is only a technology of arranging respective images near to positions on the time axis that correspond to the times added to respective images, and displaying each image according to the order and the time interval that correspond to the times, is not a technology of arranging the images by taking a priority that each image has into consideration.

Further, the technology of the Patent document 1 is adapted to display only the backward image, out of the superposed images, in a display range in which no superposition occurs when the image companions have been superposed upon each other for a purpose of displaying many images, whereby the details about the image arranged backward cannot be grasped when many images are superposed, and it does not make sense in terms of the thumbnail display.

Thereupon, the present invention has been accomplished in consideration of the above-mentioned problems, and an object thereof is to provide a content display technology that enables a content display taking a priority of the content and predetermined attribution information relating to the content into consideration to be made.

### Means to Solve the Problem

A 1st invention for solving the above-mentioned problems is a content display method of, based upon predetermined attribution information of a content, arranging and displaying the content on a screen, characterized in: deciding a priority order that is employed at the moment of arranging each content on the screen; and arranging the content in a corresponding position on the screen based upon said attribution information, and when the contents are superposedly displayed, displaying the content having a higher priority order and not displaying the content having a lower priority order.

In the above-mentioned 1st invention, the 2nd invention for solving the above-mentioned problems is characterized in arranging each content across a plurality of lines.

In the above-mentioned 2nd invention, the 3rd invention for solving the above-mentioned problems is characterized in, when each content is arranged across the plurality of the lines, reducing a display of the content being arranged in a next line as compared with a display of the content arranged in a forward line.

In the above-mentioned 2nd or 3rd inventions, the 4th invention for solving the above-mentioned problems is characterized in, when each content is arranged across the plurality of the lines, arranging the content, which is not displayed in a forward line, in a position that corresponds to a linear axis based upon said attribution information, and when the contents are superposedly displayed, displaying the content having a higher priority order and not displaying the content having a lower priority order.

In one of the above-mentioned 2nd to 4th inventions, the 5th invention for solving the above-mentioned problems is characterized in, when each content is arranged across the plurality of the lines, arranging all of the contents including the content being displayed in the forward line in a position that corresponds to a linear axis based upon said attribution information, and when the contents are superposedly displayed, displaying the content having a higher priority order and not displaying the content having a lower priority order and the content as well displayed in the forward line.

In one of the above-mentioned 2nd to 4th inventions, the 6th invention for solving the above-mentioned problems is characterized in, when each content is arranged across the plurality of the lines, arranging all of the contents in a position that corresponds to a linear axis based upon said attribution information for each line, and when the contents are superposedly displayed, displaying the content having a higher priority order and not displaying the content having a lower priority order and the content as well being displayed in a forward line.

In one of the above-mentioned 1st to 6th inventions, the 7th invention for solving the above-mentioned problems is characterized in, when the contents are superposedly displayed in a predetermined range, adjusting a position in which the content is arranged so that the contents are not superposedly displayed.

In one of the above-mentioned 1st to 7th inventions, the 8th invention for solving the above-mentioned problems is characterized in, when a caliber range of a linear axis has been changed, performing a process of an arrangement again.

In one of the above-mentioned 1st to 7th inventions, the 9th invention for solving the above-mentioned problems is characterized in previously computing and storing all of the arrangement positions of the contents at a predetermined scale of a caliber.

In the above-mentioned 9th invention, the 10th invention for solving the above-mentioned problems is characterized in, at the moment of computing all of the arrangement positions of the contents at the predetermined scale of the caliber, setting a limit so that a migration direction of the content, which migrates when the scale has been changed, is unified.

In the above-mentioned 9th invention, the 11th invention for solving the above-mentioned problems is characterized in previously grouping and storing content companions that mutually exert an influence upon the arrangement position at the predetermined scale of the caliber, and when one part of the content being displayed has been changed, deleted, or added, re-computing the arrangement position only in a range in which an arrangement of the above content is influenced.

In the above-mentioned 11th invention, the 12th invention for solving the above-mentioned problems is characterized in, when the grouped content companions are displayed at a space interval of a constant or more, narrowing its space interval and displaying the content.

The 13th invention for solving the above-mentioned problems is a content display device for, based upon predetermined attribution information of a content, arranging and displaying the content on a screen, characterized in comprising: a priority order decision means for deciding a priority order that is employed at the moment of arranging each content on the screen; and an image arrangement displaying means for arranging the content in a corresponding position on the screen based upon said attribution information, and when the contents are superposedly displayed, displaying the content having a higher priority order and not displaying the content having a lower priority order.

In the above-mentioned 13th invention, the 14th invention for solving the above-mentioned problems is characterized in that said image arrangement displaying means is configured to arrange each content across a plurality of lines.

In the above-mentioned 14th invention, the 15th invention for solving the above-mentioned problems is characterized in that said image arrangement displaying means is configured so that when each content is arranged across the plurality of the lines, a display of the content being arranged in a next line is reduced as compared with a display of the content being arranged in a forward line.

In the above-mentioned 14th or 15th inventions, the 16th invention for solving the above-mentioned problems is characterized in that said image arrangement displaying means is configured so that when each content is arranged across the plurality of the lines, the content, which is not displayed in a forward line is arranged in a position that corresponds to a linear axis based upon said attribution information, and when the contents are superposedly displayed, the content having a higher priority order is displayed, and the content having a lower priority order is not displayed.

In one of the above-mentioned 14th to 16th inventions, the 17th invention for solving the above-mentioned problems is characterized in that said image arrangement displaying means is configured so that when each content is arranged across the plurality of the lines, the contents including the content being displayed in the forward line are arranged in a position that corresponds to a linear axis based upon said attribution information, and when the contents are superposedly displayed, the content having a higher priority order is displayed, and the content having a lower priority order and the content as well being displayed in a forward line are not displayed.

In one of the above-mentioned 14th to 17th inventions, the 18th invention for solving the above-mentioned problems is characterized in that said image arrangement displaying means is configured so that when each content is arranged across the plurality of the lines, all of the contents are arranged in a position that corresponds to a linear axis based upon said attribution information for each line, and when the contents are superposedly displayed, the content having a higher priority order is displayed, and the content having the lower priority order and the content as well being displayed in the forward line are not displayed.

In one of the above-mentioned 13th to 18th inventions, the 17th invention for solving the above-mentioned problems is characterized in that said image arrangement displaying means is configured so that when the contents are superposedly displayed in a predetermined range, a position in which the content is arranged is adjusted so that the contents are not superposedly displayed.

In one of the above-mentioned 13th to 19th inventions, the 20th invention for solving the above-mentioned problems is characterized in that said image arrangement displaying means is configured to perform a process of an arrangement again when a caliber range of a linear axis has been changed.

In one of the above-mentioned 13th to 20th inventions, the 21st invention for solving the above-mentioned problems is characterized in that said image arrangement displaying means previously computes and stores all of the arrangement positions of the contents at a predetermined scale of a caliber.

In the above-mentioned 21st invention, the 22nd invention for solving the above-mentioned problems is characterized in that at the moment of computing all of the arrangement positions of the contents at the predetermined scale of the caliber, said image arrangement displaying means sets a limit so that a migration direction of the content, which migrates when the scale is changed, is unified.

In the above-mentioned 21st invention, the 23rd invention for solving the above-mentioned problems is characterized in that said image arrangement displaying means previously groups and stores content companions that mutually exert an influence upon the arrangement position at the predetermine scale of the caliber, and when one part of the content being displayed has been changed, deleted, or added, re-computes the arrangement position only in a range in which an arrangement of the above content is influenced.

In the above-mentioned 23rd invention, the 24th invention for solving the above-mentioned problems is characterized in that when the grouped content companions are displayed at an space interval of a constant or more, said image arrangement displaying means narrows its space interval and displaying the content.

The 25th invention for solving the above-mentioned problems is a program of an information processing device for, based upon predetermined attribution information of a content, arranging and displaying the content on a screen, characterized in causing the information processing device to execute: a priority order decision process of deciding a priority order that is employed at the moment of arranging each content on the screen; and a content arrangement display process of arranging the content in a corresponding position on the screen based upon said attribution information, and when the contents are superposedly displayed, displaying the content having a higher priority order and not displaying the content having a lower priority order.

In the above-mentioned 25th invention, the 26th invention for solving the above-mentioned problems is characterized in performing said content arrangement display process across a plurality of lines.

In the above-mentioned 26th invention, the 27th invention for solving the above-mentioned problems is characterized in that the content arrangement display process includes a process of, when said content arrangement display process is performed across the plurality of the lines, reducing a display of the content as compared with a display of the content arranged in a forward line.

In the above-mentioned 26th or 27th inventions, the 28th invention for solving the above-mentioned problems is characterized in that the content arrangement display process is a process of, when said content arrangement display process is performed across the plurality of the lines, arranging the content, which is not displayed in a forward line, in a position that corresponds to a linear axis based upon said attribution information, and when the contents are superposedly displayed, displaying the content having a higher priority order and not displaying the content having a lower priority order.

In one of the above-mentioned 26th to 28th inventions, the 29th invention for solving the above-mentioned problems is characterized in that, the content arrangement display process is a process of, when said content arrangement display process is performed across the plurality of the lines, arranging all of the contents including the content being displayed in the forward line in a position that corresponds to a linear axis based upon said attribution information, and when the contents are superposedly displayed, displaying the content having a higher priority order and not displaying the content having a lower priority order and the content as well being arranged in a forward line.

In one of the above-mentioned 26th to 29th inventions, the 30th invention for solving the above-mentioned problems is characterized in that the content arrangement display process is a process of, when said content arrangement display process is performed across the plurality of the lines, arranging all of the contents in a position that corresponds to a linear axis based upon said attribution information for each line, and when the contents are superposedly displayed, displaying the content having a higher priority order and not displaying the content having the lower priority order and the content as well being displayed in the forward line.

In one of the above-mentioned 26th to 30th inventions, the 31st invention for solving the above-mentioned problems is characterized in that said content arrangement display process includes a process of, when the contents are superposedly displayed in a predetermined range, adjusting a position in which the content is arranged so that the contents are not superposedly displayed.

In one of the above-mentioned 26th to 31st inventions, the 32nd invention for solving the above-mentioned problems is characterized in, when a caliber range of a linear axis has been changed, performing said content arrangement display process again.

In the above-mentioned 25th invention, the 33rd invention for solving the above-mentioned problems is characterized in that said content arrangement display process is a process of previously computing and storing all of the arrangement positions of the contents at a predetermined scale of a caliber.

In the above-mentioned 33rd invention, the 34th invention for solving the above-mentioned problems is characterized in said content arrangement display process is a process of, at the moment of computing all of the arrangement positions of the contents at the predetermined scale of the caliber, setting a limit so that a migration direction of the content, which migrates when the scale has been changed, is unified.

In the above-mentioned 33rd invention, the 35th invention for solving the above-mentioned problems is characterized in said content arrangement display process is a process of previously grouping and storing content companions that mutually exert an influence upon the arrangement position at the predetermined scale of the caliber, and when one part of the content being displayed has been changed, deleted, or added, re-computing the arrangement position only in a range in which an arrangement of the above content is influenced.

In the above-mentioned 35th invention, the 36th invention for solving the above-mentioned problems is characterized in said content arrangement display process is a process of, when the grouped content companions are displayed at an space interval of a constant or more, narrowing its space interval and displaying the content.

### An Advantageous Effect of the Invention

The present invention, which is configured to display the contents so that the contents are not superposed upon each other by taking a priority of the content into consideration at the moment of displaying the contents based upon the attribution information such as a time and as a phonetic symbol, makes it possible to make the content display that has a priority reflected therein and yet is easy to view. With this, the present invention has an excellent effect that a summary of the entirety of the contents can be easily understood.

Further, the present invention has an effect as well that combining an enlargement factor of the content image (thumbnail) accompanied by a change in a scale of the time axis etc. based upon the attribution information such as the time, and a reduction factor at the moment of displaying the content images (thumbnails) in plural lines makes it easy to forecast a display of the content images (thumbnails) at the time of performing an enlargement/reduction operation of the scale.

### BRIEF DESCRIPTION OF THE DRAWINGS

FIG. 1 is a view for explaining a first content arrangement/display method.

FIG. 2 is a view for explaining the first content arrangement/display method.

FIG. 3 is a view for explaining the first content arrangement/display method.

FIG. 4 is a view for explaining the first content arrangement/display method.

FIG. 5 is a view for explaining the first content arrangement/display method.

FIG. 6 is a view for explaining the first content arrangement/display method.

FIG. 7 is a view for explaining the first content arrangement/display method.

FIG. 8 is a view for explaining the first content arrangement/display method.

FIG. 9 is a view for explaining the first content arrangement/display method.

FIG. 10 is a view for explaining the first content arrangement/display method.

FIG. 11 is a view for explaining the first content arrangement/display method.

FIG. 12 is a view for explaining the first content arrangement/display method.

FIG. 13 is a view for explaining the first content arrangement/display method.

FIG. 14 is a view for explaining the first content arrangement/display method.

FIG. 15 is a view for explaining the first content arrangement/display method.

FIG. 16 is a view for explaining the first content arrangement/display method.

FIG. 17 is a view for explaining the first content arrangement/display method.

FIG. 18 is a view for explaining the first content arrangement/display method.

FIG. 19 is a view for explaining the first content arrangement/display method.

FIG. 20 is a view for explaining the first content arrangement/display method.

FIG. 21 is a view for explaining a second content arrangement/display method.

FIG. 22 is a view for explaining the second content arrangement/display method.

FIG. 23 is a view for explaining the second content arrangement/display method.

FIG. 24 is a view for explaining the second content arrangement/display method.

FIG. 25 is a view for explaining the second content arrangement/display method.

FIG. 26 is a view for explaining the second content arrangement/display method.

FIG. 27 is a view for explaining the second content arrangement/display method.

FIG. 28 is a view for explaining the second content arrangement/display method.

FIG. 29 is a view for explaining the second content arrangement/display method.

FIG. 30 is a view for explaining the second content arrangement/display method.

FIG. 31 is a view for explaining the second content arrangement/display method.

FIG. 32 is a view for explaining the second content arrangement/display method.

FIG. 33 is a view for explaining the second content arrangement/display method.

FIG. 34 is a block diagram of a first embodiment.

FIG. 35 is a flowchart of the first embodiment.

FIG. 36 is a view for explaining an operation of the first embodiment.

FIG. 37 is a block diagram of a second embodiment.

FIG. 38 is a flowchart of the second embodiment.

FIG. 39 is a view for explaining an operation of the second embodiment.

FIG. 40 is a view for explaining a third embodiment.

FIG. 41 is a view for explaining the second content arrangement/display method.

FIG. 42 is a view for explaining a fourth embodiment.

FIG. 43 is a view for explaining the fourth embodiment.

FIG. 44 is a general block configuration diagram of an information processing system into which the content display device of the present invention has been implemented.

FIG. 45 is a view for explaining the second content arrangement/display method.

FIG. 46 is a view for explaining a fifth embodiment.

FIG. 47 is a view for explaining the fifth embodiment.

FIG. 48 is a view for explaining the fifth embodiment.

FIG. 49 is a view for explaining a sixth embodiment.

FIG. 50 is a view for explaining a seventh embodiment.

FIG. 51 is a view for explaining the seventh embodiment.

### DESCRIPTION OF NUMERALS

10 content data storage section

11 input section

12 priority order determination section

13 linear information computation section

14 thumbnail creation section

15 thumbnail one-line arrangement section

16 superposed thumbnail non-display section

17 display scale specifying section

18 display section

20 thumbnail reduction section

21 thumbnail simplification section

30 display scale storage section

31 arrangement information storage section

32 display scale selection section

40 group information storage section

### BEST MODE FOR CARRYING OUT THE INVENTION

At first, an arrangement/display method of the present invention will be explained by employing the accompanied drawings.

The present invention is characterized in including the arrangement/display method of, based upon the image such as a picture, and the linear information, being numerical value information computed from the attribution information (a photographing time, a phonetic symbol, or the like) of the content such as a telephone number, arranging and displaying its content images on the display screen so that while a priority of the content is taken into consideration, they are not superposed upon each other.

A summary of the first content arrangement/display method will be explained by employing the accompanied drawings.

The following explanation is made on the assumption that the content image is a picture image, and each picture image includes a photographing date (attribution information) and a priority affixed by a user. And, the case will be explained of arranging the picture image in a corresponding position of the time axis based upon numerical value information, being linear information computed from the photographing date of the picture. Additionally, the numerical value information, being linear information, is a coordinate position on the screen, or the like, and the following explanation is made by replacing the numerical value information, being linear information, with the numerical value of the photographing time for facilitating the understanding. Further, the numerical figure in the picture image shown in each figure signifies the photographing date and the priority.

At first, the case that a range of the time axis of the display screen range is between 2005/10/1 and 2005/10/2, and seven picture images are arranged in the position that corresponds to this time axis will be explained.

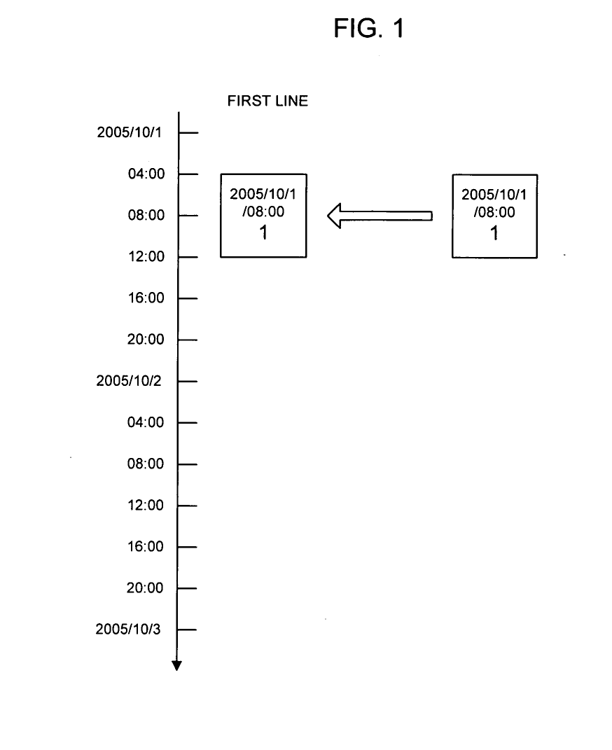

As shown in FIG. 1, the picture image of which the photographing date and the priority order are 2005/10/1/08:00 and a first place, respectively, is arranged and displayed in the position that corresponds to the time axis.

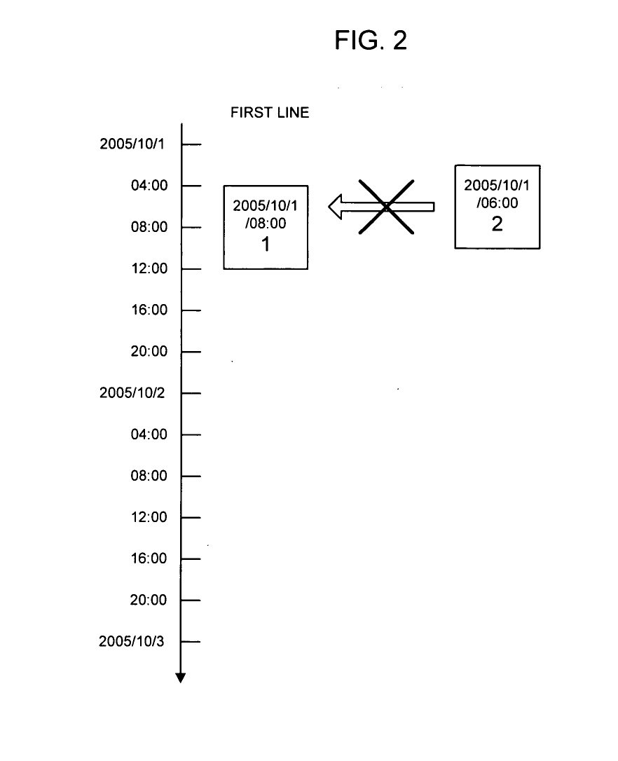

Continuously, as shown in FIG. 2, the picture image of which the photographing date and the priority order are 2005/10/1/06:00 and a second place, respectively, is not arranged because it is superposed upon the already-arranged picture image if it is to be arranged in the position that corresponds to the time axis.

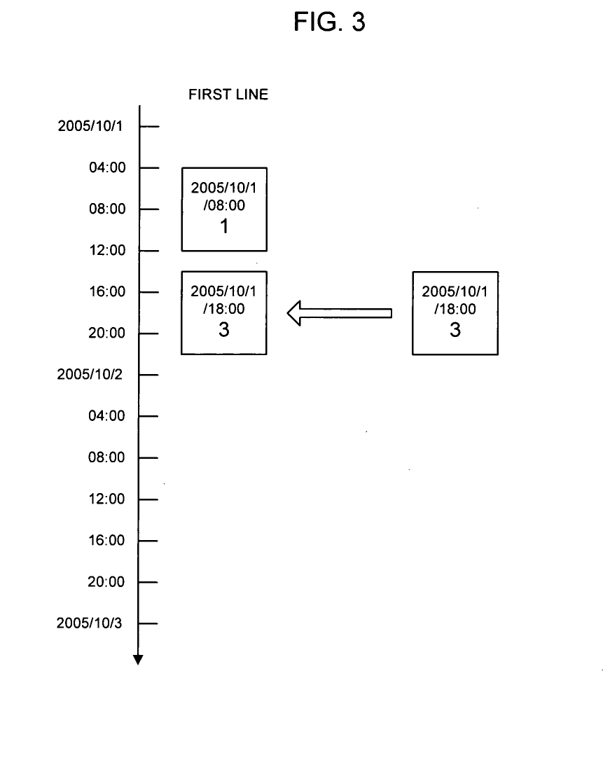

As shown in FIG. 3, the picture image of which the photographing date and the priority order are 2005/10/1/18:00 and a third place, respectively, is arranged and displayed in the position that corresponds to the time axis because it is not superposed upon either of the picture images.

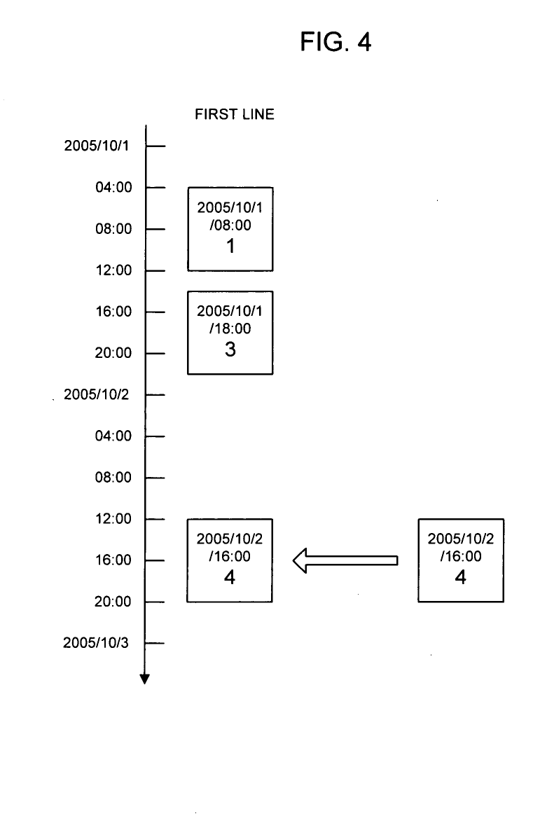

As shown in FIG. 4, the picture image of which the photographing date and the priority order are 2005/10/2/16:00 and a fourth place, respectively, is arranged and displayed in the position that corresponds to the time axis because it is not superposed upon either of the picture images.

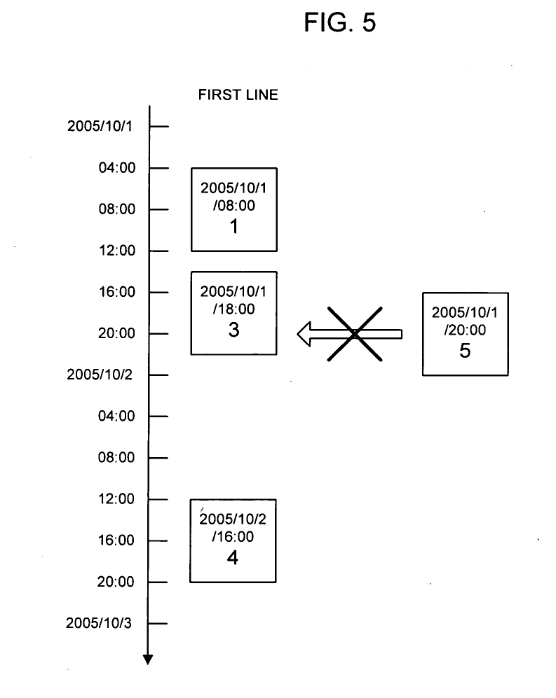

As shown in FIG. 5, the picture image of which the photographing date and the priority order are 2005/10/1/20:00 and a fifth place, respectively, is not arranged because it is superposed upon the already-arranged picture image if it is to be arranged in the position that corresponds to the time axis.

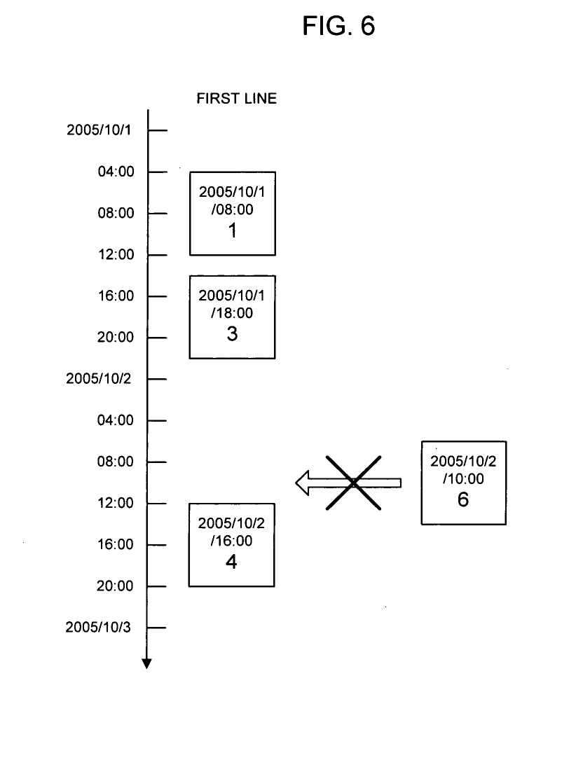

As shown in FIG. 6, the picture image of which the photographing date and the priority order are 2005/10/2/10:00 and a sixth place, respectively, is not arranged because it is superposed upon the already-arranged picture image if it is to be arranged in the position that corresponds to the time axis.

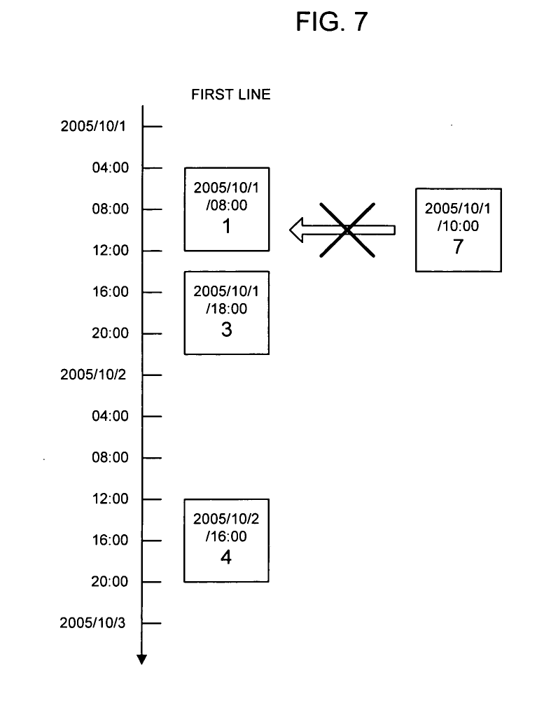

As shown in FIG. 7, the picture image of which the photographing date and the priority order are 2005/10/1/10:00 and a seventh place, respectively, is not arranged because it is superposed upon the already-arranged picture image if it is to be arranged in the position that corresponds to the time axis.

The picture images are arranged in a first line in such a manner.

Next, the picture images that could not be arranged in the first line are arranged in a second line. With the method of arranging the picture images in this second line, a selection/arrangement operation similar to the case of the foregoing first line is performed for the picture images except for the picture images arranged in the first line.

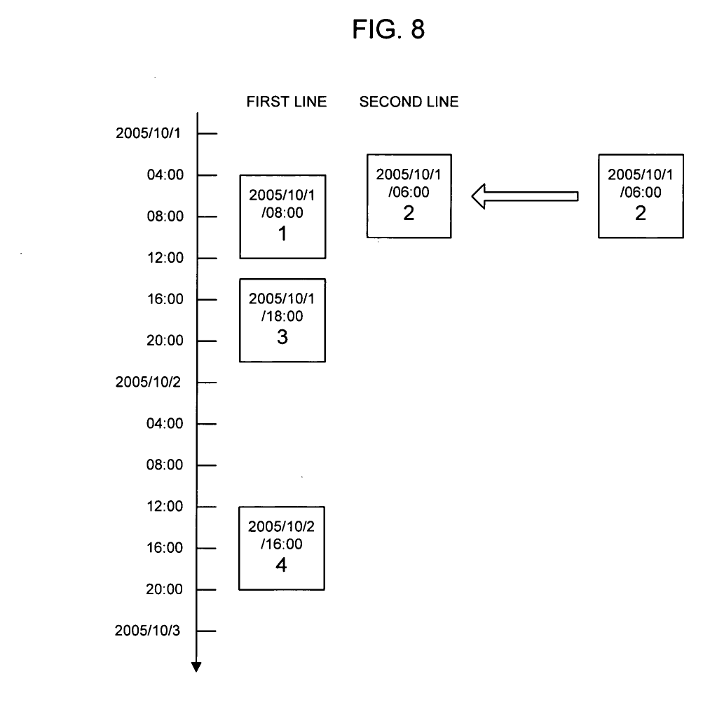

As shown in FIG. 8, the picture image having a second-place priority order that could not be arranged in the first line is arranged and displayed in the position that corresponds to the second-line time axis.

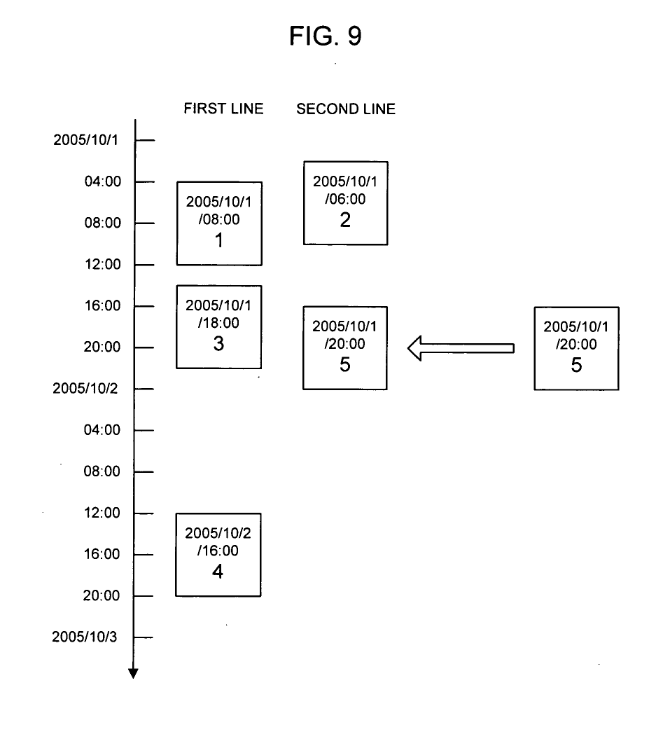

Continuously, as shown in FIG. 9, the picture image having a fifth-place priority order that could not be arranged in the first line is arranged and displayed in the position that corresponds to the time axis because it is not superposed upon either of the picture images.

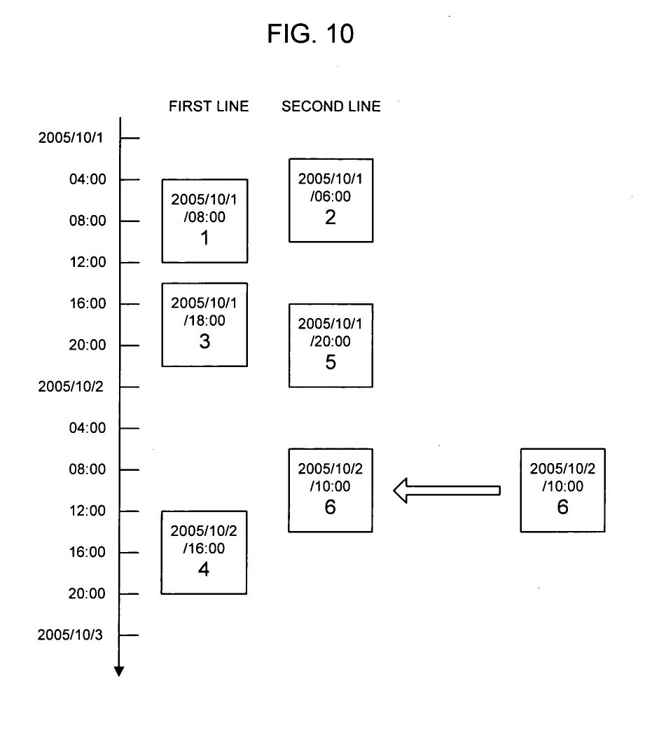

As shown in FIG. 10, the picture image having a sixth-place priority order that could not be arranged in the first line is arranged and displayed in the position that corresponds to the time axis because it is not superposed upon either of the picture images.

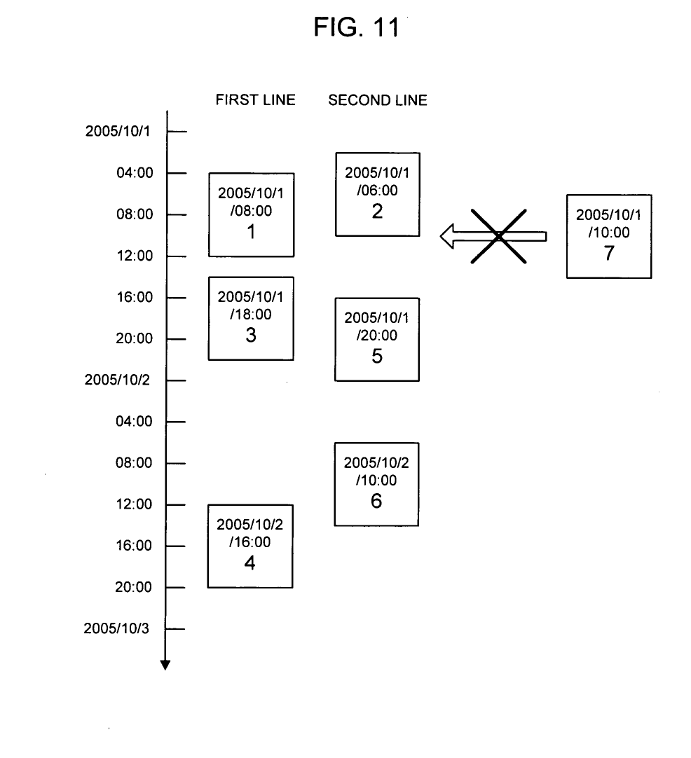

As shown in FIG. 11, the picture image having a seventh-place priority order that could not be arranged in the first line is not arranged because it is superposed upon the already-arranged picture image if it is to be arranged in the position that corresponds to the time axis.

The picture images are arranged in the second line in such a manner.

Next, the picture images that could not be arranged in the first line and the second line are arranged in a third line. With the method of arranging the picture images in this third line, a selection/arrangement operation similar to the case of the foregoing first line and second line is performed for the picture images except for the picture images arranged in the first line and the second line.

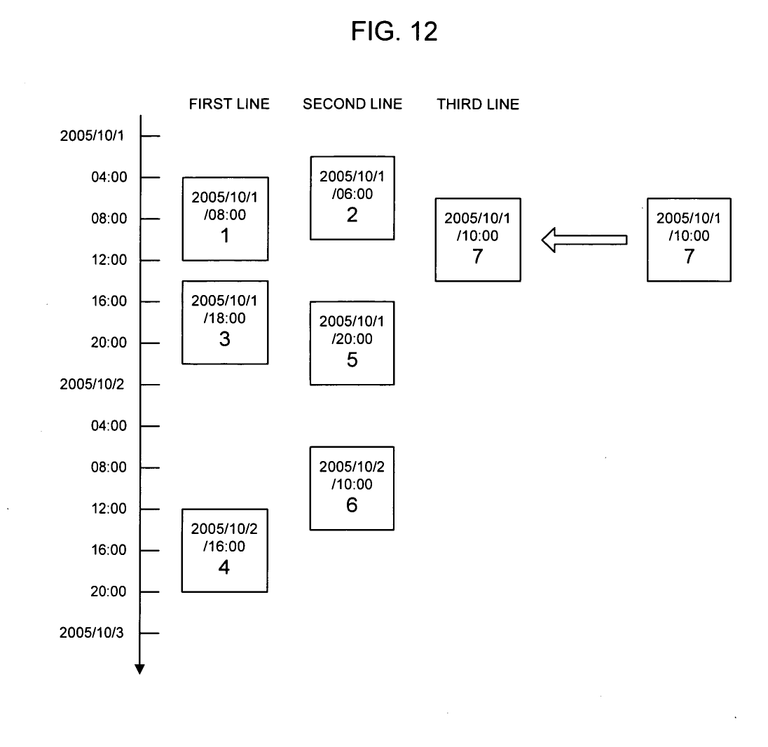

As shown in FIG. 12, the picture image except for the picture images arranged in the first line and the second line, which is a picture image having a seventh-place priority order, is arranged and displayed in the position that corresponds to the time axis because it is not superposed upon either of the picture images.

In such a manner, the picture images are arranged by repeatedly performing an arrangement operation until all of the picture images within the caliber range are arranged. However, it does not matter that the picture images are arranged only in an arbitrary number of the lines so long as there is a limit to the number of the lines due to the display screen's space or the like.

Continuously, the case of changing a caliber of the time axis in the above-mentioned example will be explained.

In the present invention, the time axis can be set at an arbitrary caliber, and the caliber of the time axis ranging from a date 2005/10/1 to a date 2005/10/2 was set in the foregoing example. Herein, the case of changing the caliber of the time axis to a date 2005/10/1 accompanied by changing the caliber by the user will be explained. Additionally, it is assumed that the size of the picture image being arranged is a size similar to that of the foregoing example.

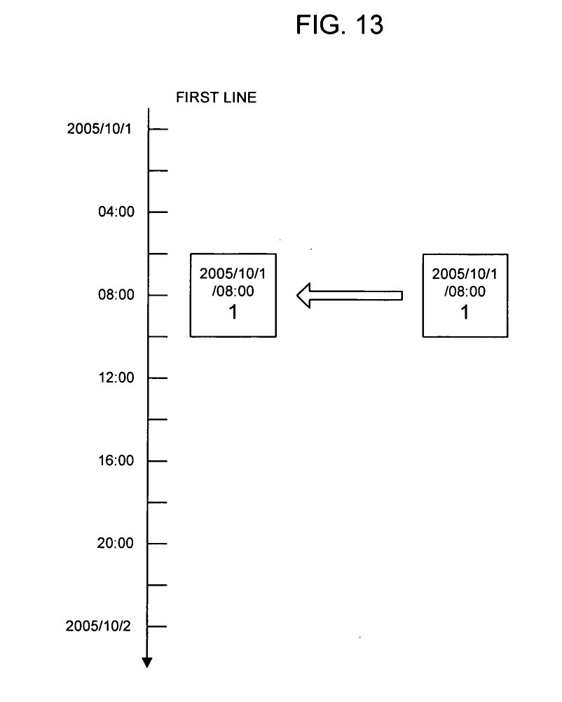

At first, as shown in FIG. 13, the picture image of which the photographing date and the priority order are 2005/10/1/08:00 and a first place, respectively, is arranged and displayed in the position that corresponds to the time axis.

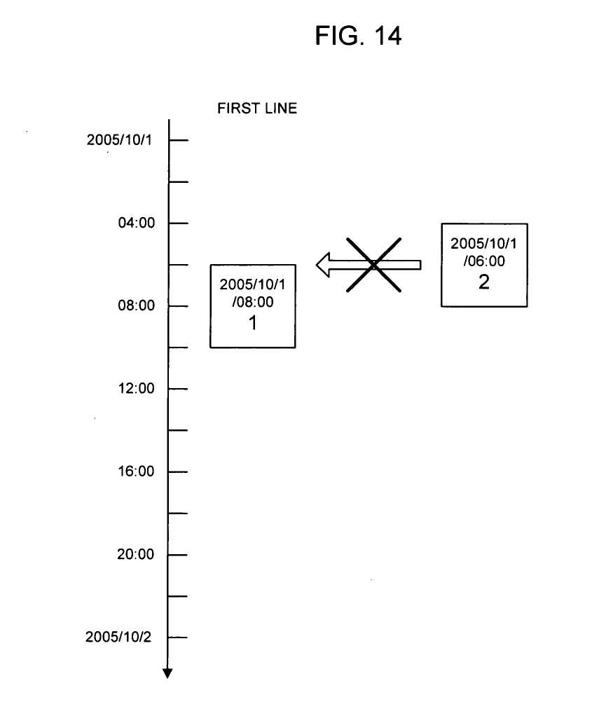

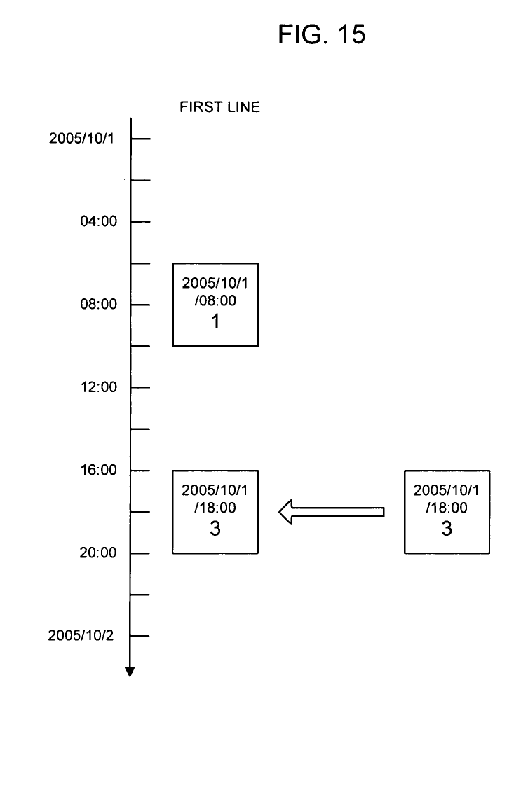

Continuously, as shown in FIG. 14, the picture image of which the photographing date and the priority order are 2005/10/1/06:00 and a second place, respectively, is not arranged because it is superposed upon the already-arranged picture image if it is to be arranged in the position that corresponds to the time axis.

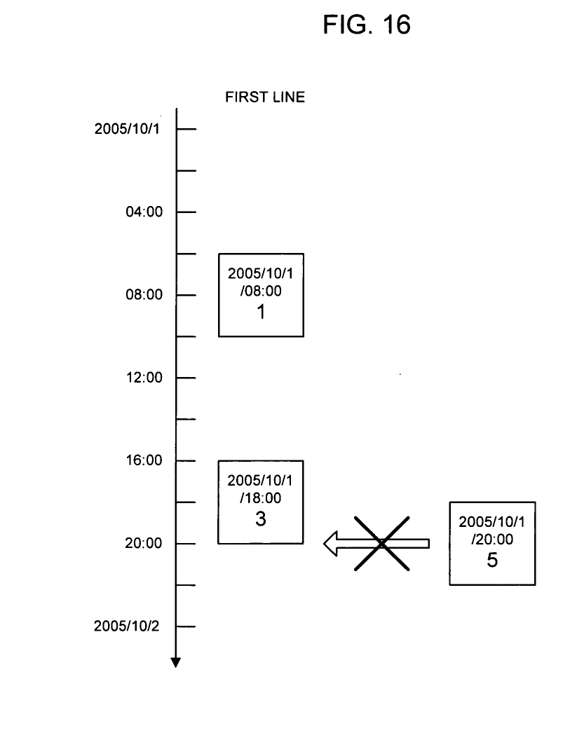

As shown in FIG. 15, the picture image of which the photographing date and the priority order are 2005/10/1/18:00 and a third place, respectively, is arranged and displayed in the position that corresponds to the time axis because it is not superposed upon either of the picture images.

As shown in FIG. 16, the picture image of which the photographing date and the priority order are 2005/10/1/20:00 and a fifth place, respectively, is not arranged because it is superposed upon the already-arranged picture image if it is to be arranged in the position that corresponds to the time axis.

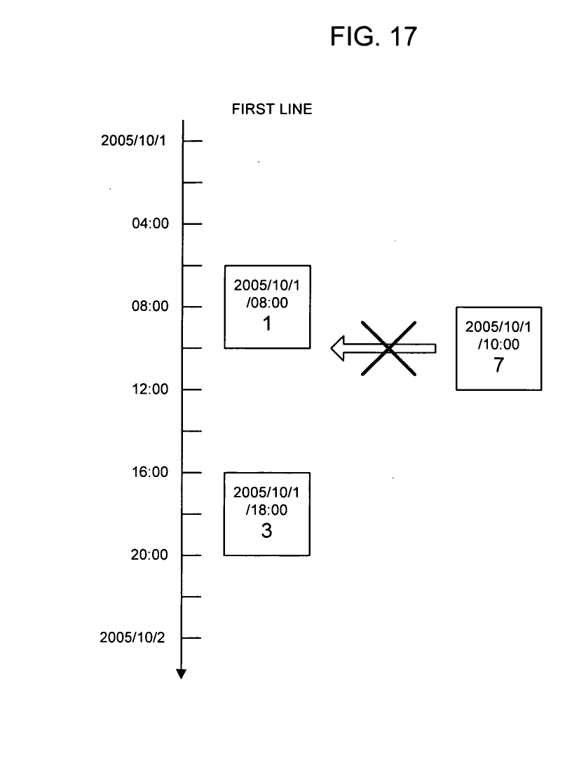

As shown in FIG. 17, the picture image of which the photographing date and the priority order are 2005/10/1/10:00 and a seventh place, respectively, is not arranged because it is superposed upon the already-arranged picture image if it is to be arranged in the position that corresponds to the time axis.

Next, the picture images that could not be arranged in the first line are arranged in the second line. With the method of arranging the picture images in this second line, similarly to the foregoing example, a selection/arrangement operation similar to the case of the foregoing first line is performed for the picture images except for the picture images arranged in the first line.

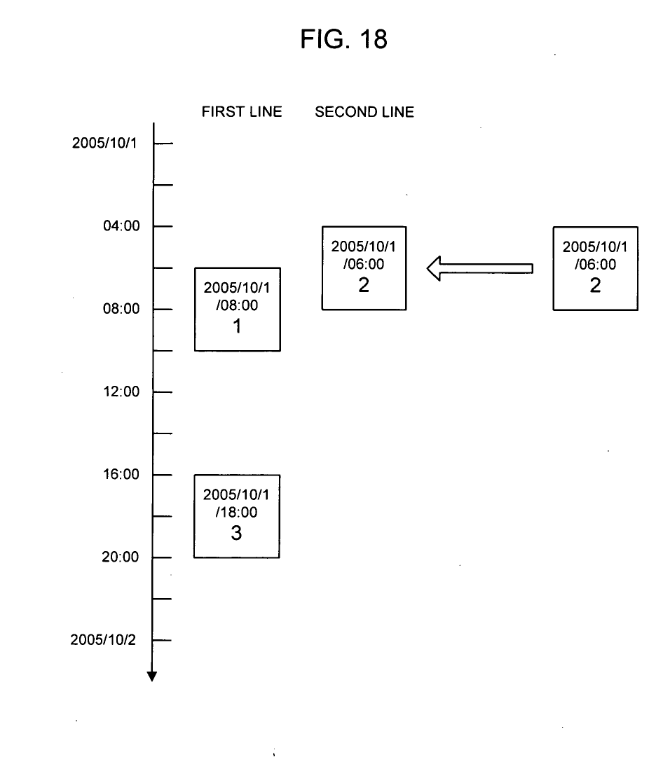

As shown in FIG. 18, the picture image having a second-place priority order that could not be arranged in the first line is arranged and displayed in the position that corresponds to the second-line time axis.

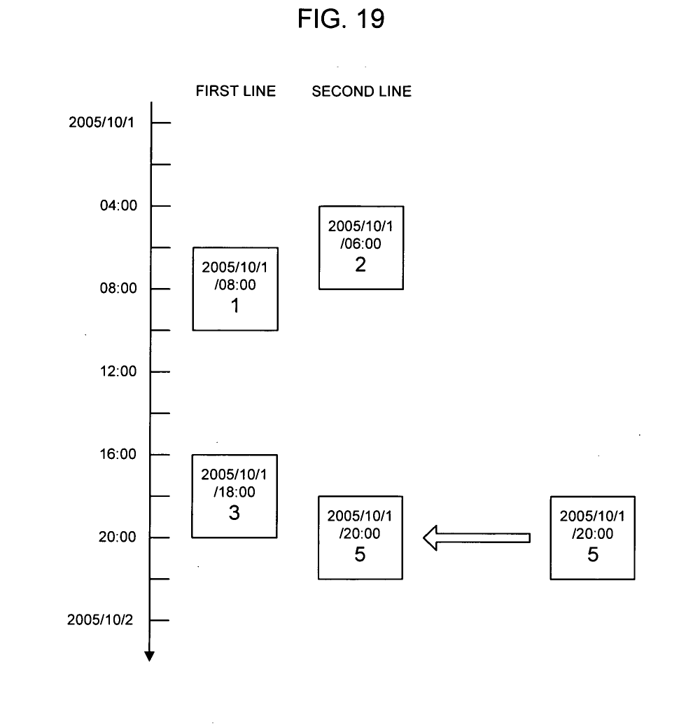

Continuously, as shown in FIG. 19, the picture image having a fifth-place priority order that could not be arranged in the first line is arranged and displayed in the position that corresponds to the time axis because it is not superposed upon either of the picture images.

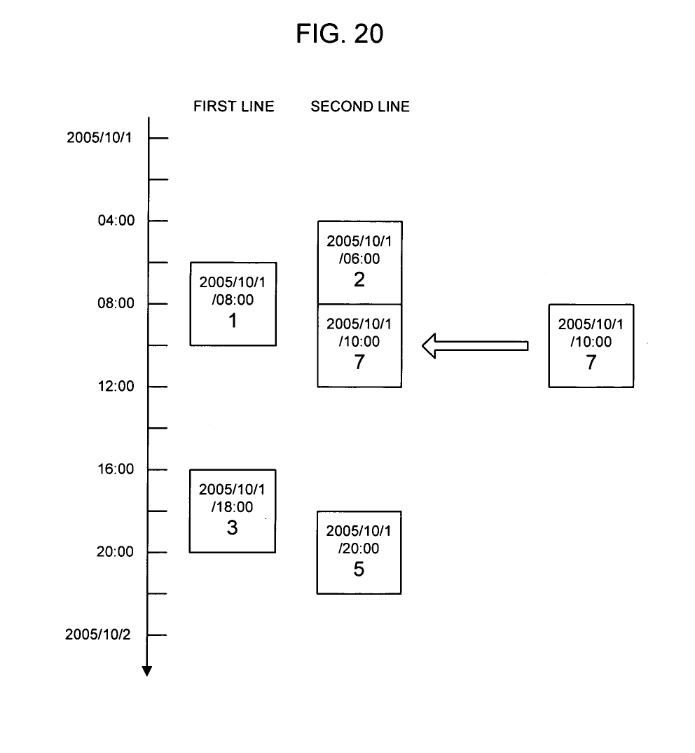

As shown in FIG. 20, the picture image having a seventh-place priority order that could not be arranged in the first line is arranged and displayed in the position that corresponds to the time axis because it is not superposed upon either of the picture images.

The picture images are arranged in the second line in such a manner.

Changing the caliber in such a manner causes the picture image so far arranged in the low-order line to migrate to the high-order line, thereby enabling the arrangement, which is appropriate from a viewpoint of vision, to be made in its caliber.

Next, a summary of a second content arrangement/display method different from the foregoing first content arrangement/display method will be explained below.

The second content arrangement/display method is identical to the first content arrangement/display method in arranging and displaying the contents so that they are not superposed upon each other; however the former, differently from the latter, incorporates a technique of lessening the size of the content being displayed in the second line and the line after it, and as a result, slightly differs from the latter in a technique of arranging/displaying the picture image.

The following explanation is made on the assumption that, similarly to the foregoing first content arrangement/display method, the content image is a picture image, and each picture includes the photographing date (attribution information) and the priority affixed by the user. And, the case will be explained of arranging the picture image in the corresponding position of the time axis based upon numerical value information, being linear information computed from the photographing date of the picture. Additionally, the numerical value information, being linear information, is a coordinate position on the screen, or the like, and the following explanation is made by replacing the numerical value information, being linear information, with the numerical value of the photographing time for facilitating the understanding. Further, the numerical figure in the picture image shown in each figure signifies the photographing date and the priority.

The second content arrangement/display method is identical to the foregoing first content arrangement/display method with regard to the first-line arrangement/display, so its explanation is omitted, and the arrangement in the second line and the line after it will be explained.

With the method of arranging the picture images in the second line, a selection operation similar to the case of the foregoing first line is performed for the picture images including the picture images, which have been selected in the first line, and of which the arrangement has been decided. However, as mentioned above, the size of the second-line picture image becomes a half of that of the first-line picture image, and the arrangement/display is decided according to this size.

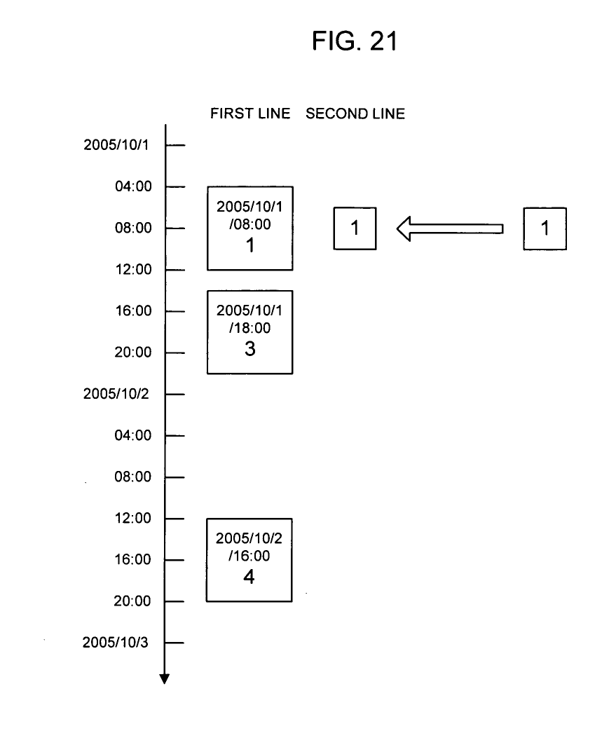

At first, as shown in FIG. 21, the picture image of which the photographing date and the priority order are 2005/10/1/08:00 and a first place, respectively, is arranged at a half size of the first-line picture image in the position that corresponds to the time axis.

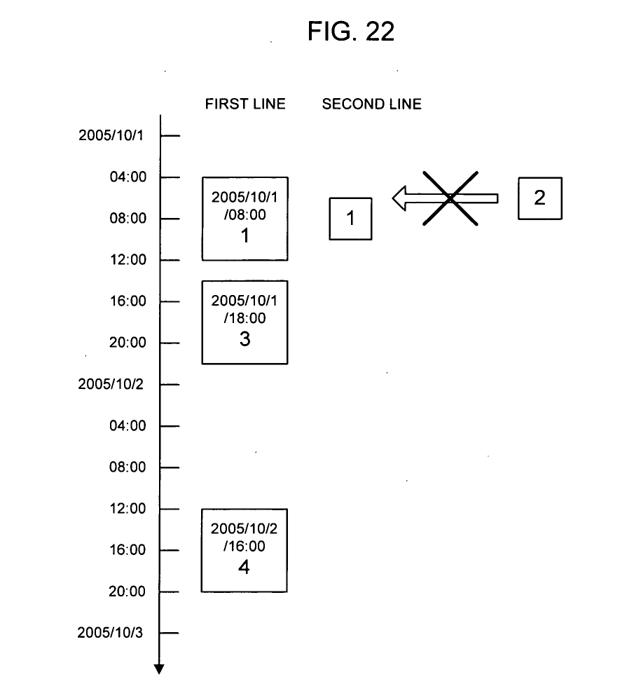

Continuously, as shown in FIG. 22, the picture image of which the photographing date and the priority order are 2005/10/1/06:00 and a second place, respectively, is not arranged because it is superposed upon the already-arranged picture image if it is to be arranged in the position that corresponds to the time axis.

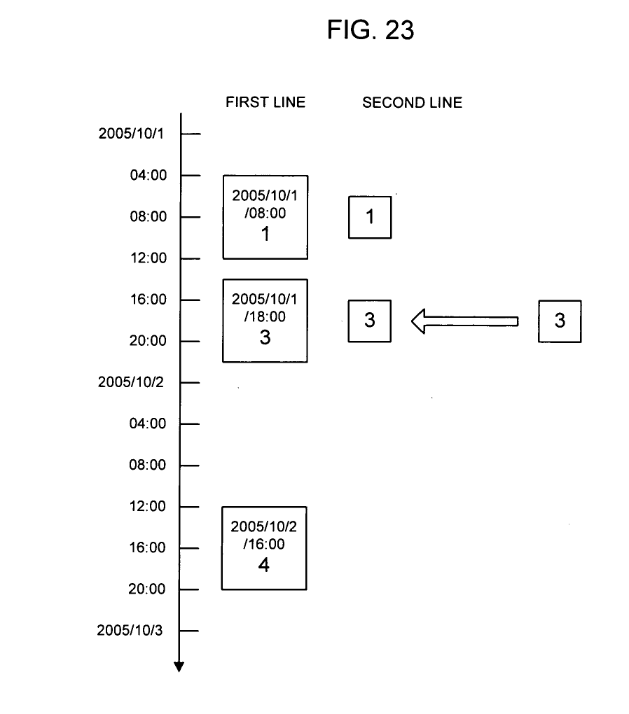

As shown in FIG. 23, the picture image of which the photographing date and the priority order are 2005/10/1/18:00 and a third place, respectively, is arranged in the position that corresponds to the time axis because it is not superposed upon either of the picture images.

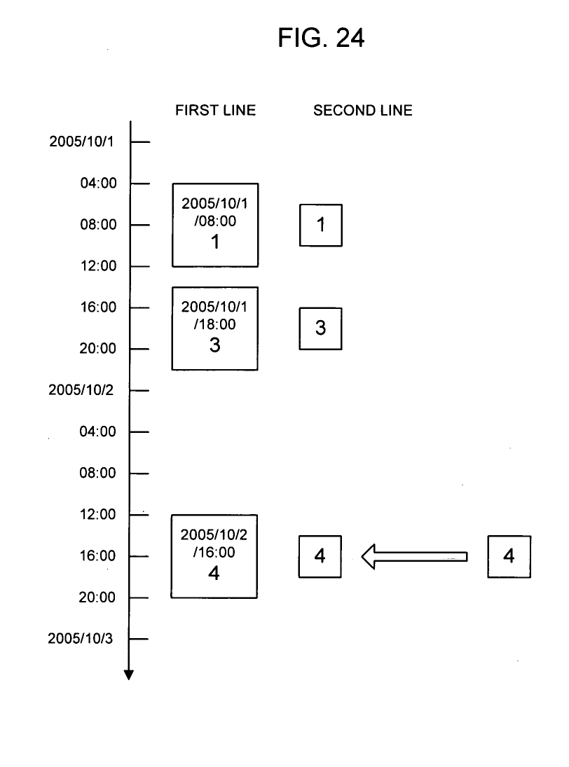

As shown in FIG. 24, the picture image of which the photographing date and the priority order are 2005/10/2/16:00 and a fourth place, respectively, is arranged in the position that corresponds to the time axis because it is not superposed upon either of the picture images.

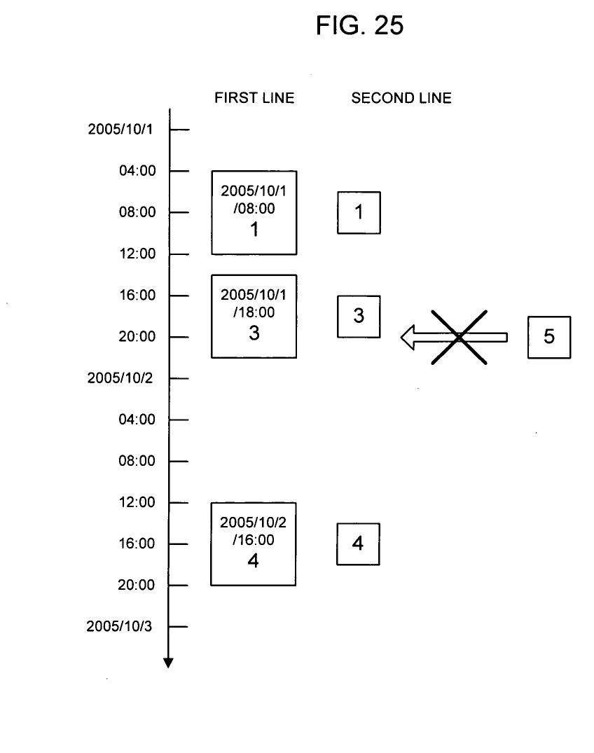

As shown in FIG. 25, the picture image of which the photographing date and the priority order are 2005/10/1/20:00 and a fifth place, respectively, is not arranged because it is superposed upon the already-arranged picture image if it is to be arranged in the position that corresponds to the time axis.

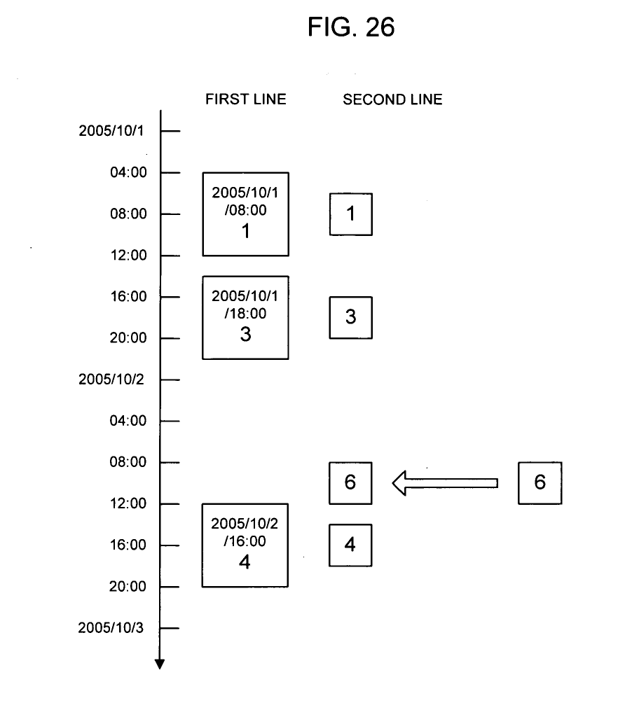

As shown in FIG. 26, the picture image of which the photographing date and the priority order are 2005/10/2/10:00 and a sixth place, respectively, is arranged in the position that corresponds to the time axis because it is not superposed upon either of the picture images.

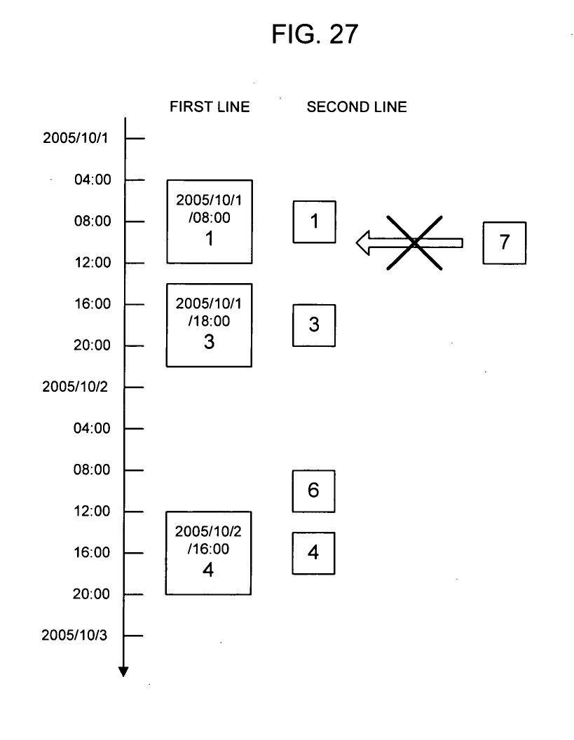

As shown in FIG. 27, the picture image of which the photographing date and the priority order are 2005/10/1/10:00 and a seventh place, respectively, is not arranged because it is superposed upon the already-arranged picture image if it is to be arranged in the position that corresponds to the time axis.

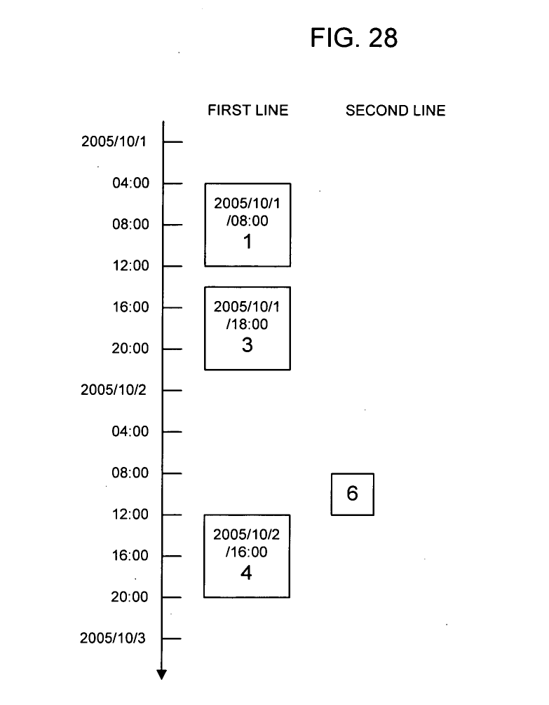

The picture images being arranged in the second line are selected in such a manner, and the picture images already being arranged and displayed in the first line are not arranged/displayed in the second line because they are repeated, and as shown in FIG. 28, only the picture image having a sixth-place priority order is arranged in the second line.

Continuously, with the method of arranging the picture images in the third line, a selection operation similar to the case of the foregoing first line is performed for the picture images including the picture images, which have been selected in the first line and the second line, and of which the arrangement/display has been decided. However, as mentioned above, the size of the third-line picture image becomes a half of that of the second-line picture image, and the arrangement/display is decided according to this size.

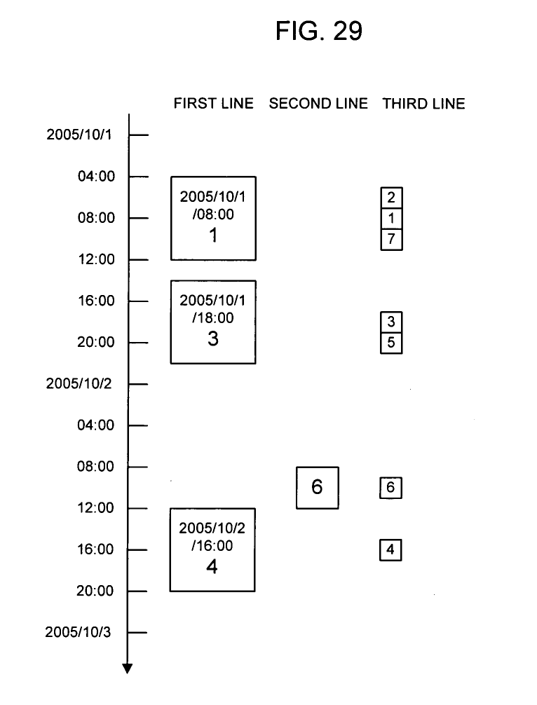

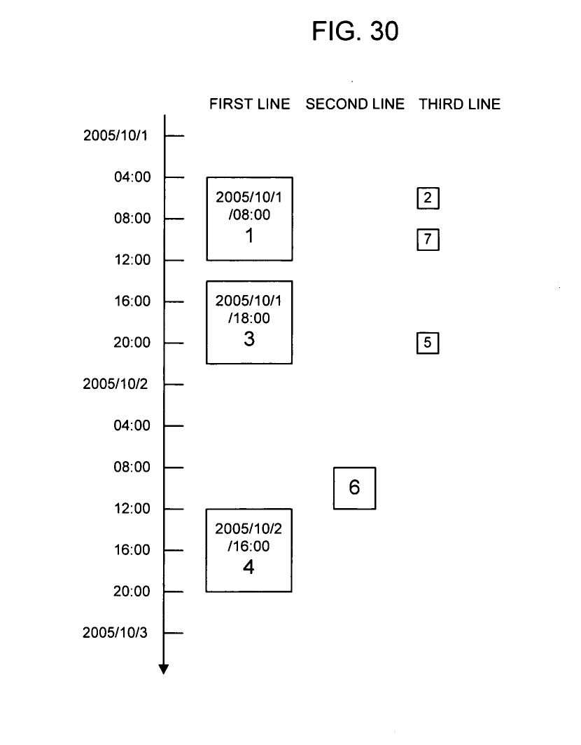

That is, as shown in FIG. 29, even if all of the picture images including the picture image selected in the first line and the second line are arranged at a half size of the second-line picture image in the position that corresponds to the time axis, they are not superposed upon each other, namely, they are arrangeable. Of these picture images, the picture image having a first-place priority order, the picture image having a third-place priority order, the picture image having a fourth-place priority order, and the picture image having a sixth-place priority order are not repeatedly arranged/displayed in the third line because they have already arranged and displayed in the first line or the second line. Thus, as shown in FIG. 30, the picture images being arranged and displayed in the third line are the picture image having a second-place priority order, the picture image having a seventh-place priority order, and the picture image having a fifth-place priority order.

The second content arrangement/display method, as compared with the first content arrangement/display method, has an advantage that many images can be arranged in fewer lines because the size of the image becomes smaller all the more as it ranks in more backward line.

Continuously, the case of changing the caliber of the time axis in the above-mentioned example will be explained.

The second content arrangement/display method, similarly to the foregoing first content arrangement/display method, enables the time axis to be set at an arbitrary caliber, and the caliber of the time axis was set to a range from a date 2005/10/1 to a date 2005/10/2 in the foregoing example. Herein, the case of changing the caliber of the time axis to a date 2005/10/1 accompanied by changing the caliber by the user will be explained. Additionally, it is assumed that, with the size of the picture image being arranged, the size of the backward-line picture image, similar to the case of the foregoing example, is a half of that of the forward-line picture image.

Also with the caliber change, the second content arrangement/display method is identical to the foregoing first content arrangement/display method with regard to the arrangement in the first line, so its explanation is omitted, and the arrangement in the second line and the line after it will be explained.

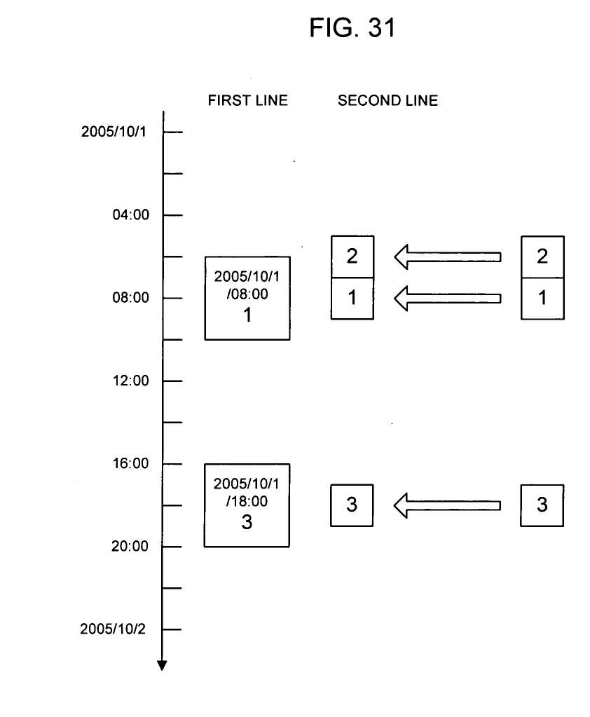

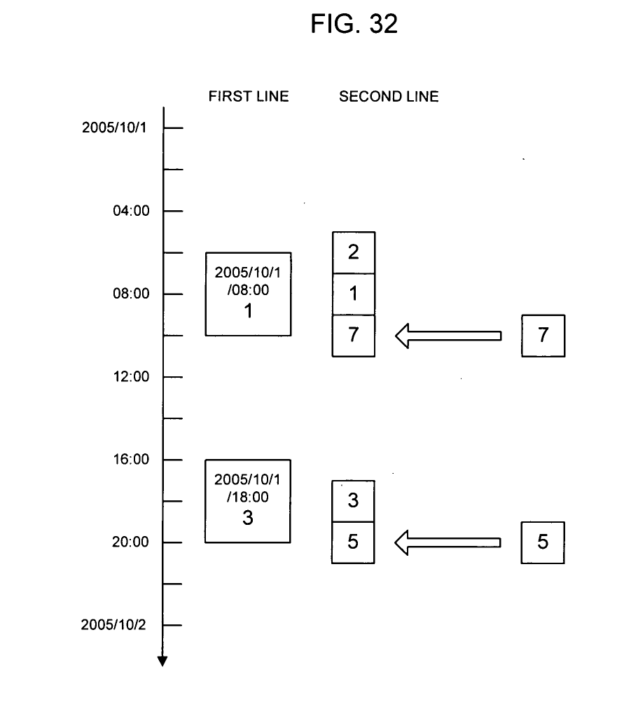

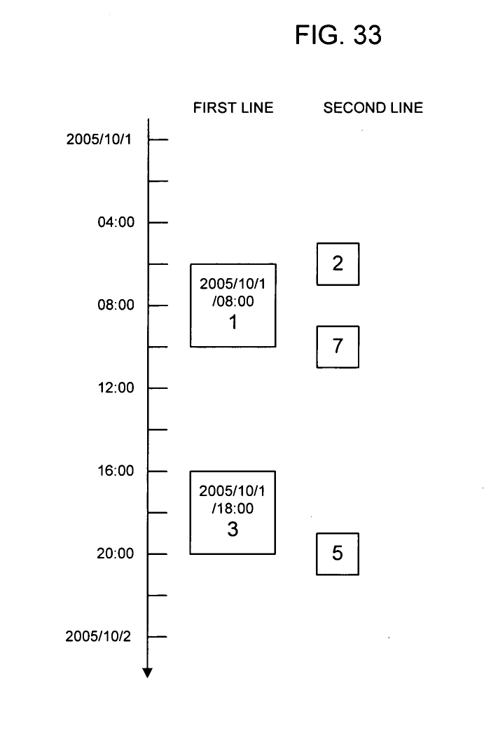

With the method of arranging the picture images in the second line, a selection operation similar to the case of the foregoing first line is performed for the picture images including the picture images, which have been selected in the first line, and of which the arrangement/display has been decided. However, as mentioned above, the size of the second-line picture image becomes a half of that of the first-line picture image, and the selection is decided according to this size.

Whereupon, as shown in FIG. 31, the picture image having a first-place priority order, the picture image having a second-place priority order, and the picture image having a third-place priority order are arranged in the second line in its order, and as shown in FIG. 32, all of the picture images each of which has a photographing date 2005/10/1 can be arranged in the second line without being superposed upon each other. Herein, the picture images already arranged in the first line are not arranged/displayed in the second line because they are repeated. Whereupon, as shown in FIG. 33, the picture image having a second-place priority order, the picture image having a seventh-place priority order, and the picture image having a fifth-place priority order are arranged in the second line.

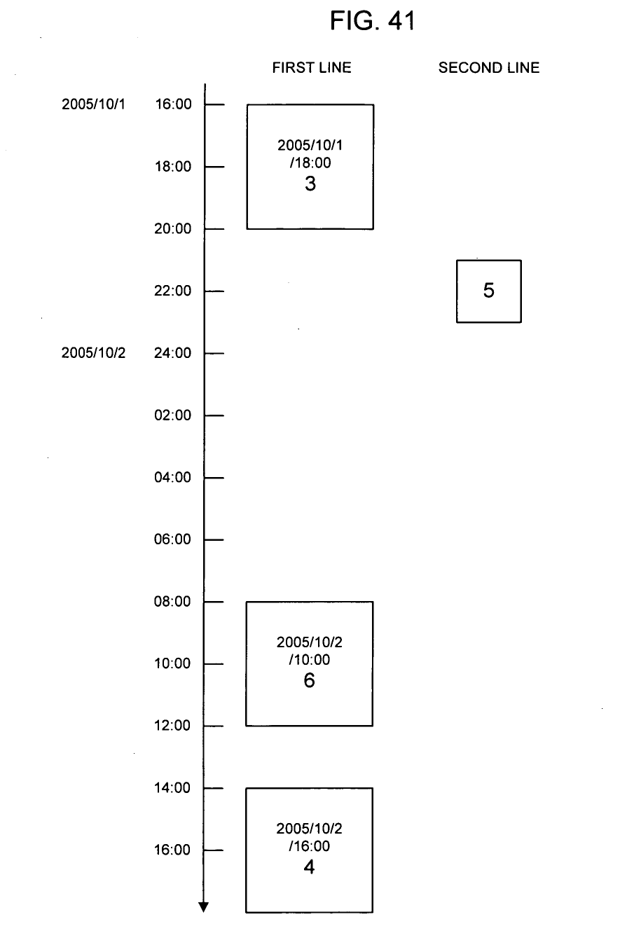

Further, as shown in FIG. 41, when the caliber of the time axis is changed from a date 2005/10/1/16:00 to a date 2005/10/2/16:00, the picture image having a sixth-place priority order arranged in the second line in FIG. 30 is arranged and displayed in the first line, and the picture image having a fifth-place priority order arranged in the third line is arranged and displayed in the second line.

Such a second content arrangement/display method is a method in which pre-setting the scale of the caliber range so that a magnification factor of an enlargement of the scale and a reduction factor of the picture image being arranged in the second line and the line after it are caused to correspond to each other, for example, pre-setting the scale of the caliber range in such a manner that it is enlarged by a factor of two, four, eight, . . . , or reduced in half, and setting the size of the picture image so that it is a half of that of the forward-line picture image enable the user to visually forecast the arrangement, and to easily retrieve the content as well such as the picture image because the picture image positioned in the backward line is arranged in the forward line, for example, the picture image positioned in the second line is arranged in the first line whenever the scale of the caliber range is enlarged, and further, when the scale of the caliber range is reduced, vice versa, that is, the picture image positioned in the forward line is arranged in the backward line.

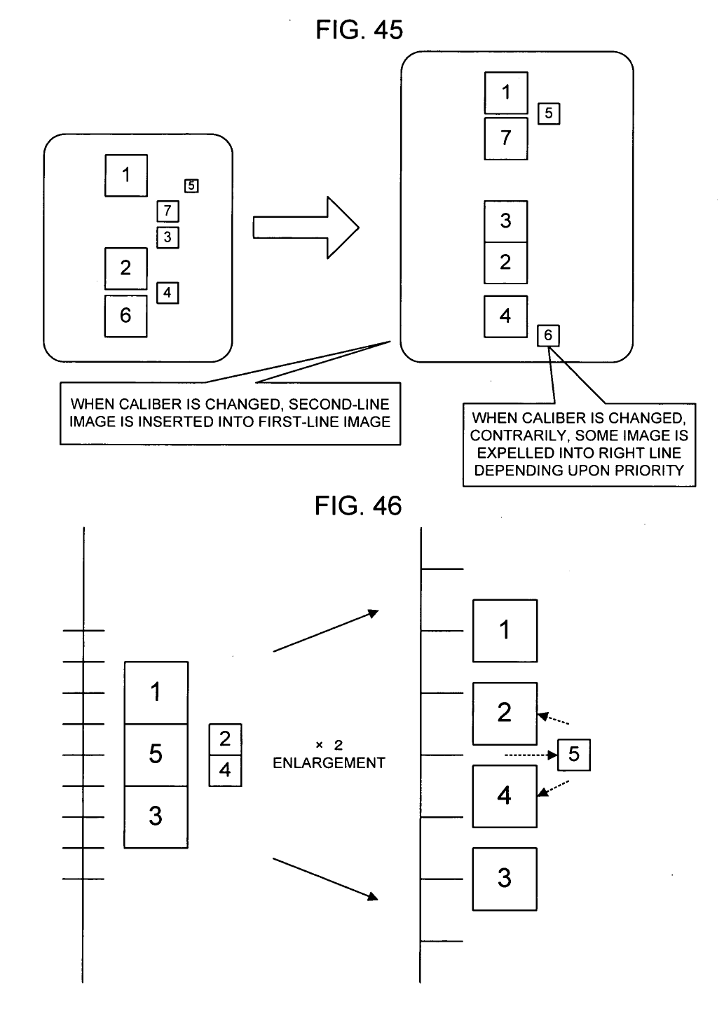

Additionally, when the foregoing decision of the arrangement is made whenever the caliber range is changed, as shown in FIG. 45, some picture image could be expelled into in the line (having a low priority) that ranks righter than the line in which it was arranged so far, depending upon a priority. Thereupon, so as to prevent the image so far displayed in the forward line from being pushed out by the picture image added from the backward line, and from going out of sight when the caliber is enlarged, a classification of the display/non-display of the image at each caliber is obtained in advance. At that moment, sequentially operating a computation for the lines, to begin with the utmost right line (that is in a status where the caliber has been enlarged to the most), and deciding the display so that the image, which has not been displayed in the line that ranks righter by one line, is not surely displayed in its line as well (simple reduction) allow a transition in the display at the time of changing the caliber to be smoothly made.

The above explanation was made on the assumption that the content was a picture image, the attribution information was a photographing time, and the priority was a priority affixed by the user, however theses content, attribution information, and photographing time are not limited hereto.

For example, the content could be not only a picture image but also a moving picture, each sheet of a presentation document, or the like.

As attribution information, a photographing position (GPS information etc.), a time code of the moving image, interval information into which a difference of a text of the forward sheet and that of the backward sheet has been reflected, or the like is acceptable.

A configuration may be made so that the photographing time interval, being a difference between the photographing time of the forward picture and that of the backward picture, is assumed to be a priority, and the picture having a larger photographing time interval is given a higher priority order. Assuming the photographing time interval to be a priority gives rise to a merit that the characteristic picture is given a high priority because a possibility that the nearer the photographing times of the pictures are to each other, the more closely its texts resemble to each other is high. Further, a configuration may be made so that the number of times of a user's perusal or the user's perusal time is assumed to be a priority, and the priority order is affixed to the content in the descending order of the number of times or the perusal time. In addition hereto, a configuration may be made so that the difference between sheets of the presentation document is assumed to be a priority, and the content having a larger difference ranks in a higher priority order.

Next, a first embodiment of the present invention will be explained by making a reference to the accompanied drawings.

The first embodiment, which is equivalent to the foregoing first content arrangement/display method, assumes a slightly different method.

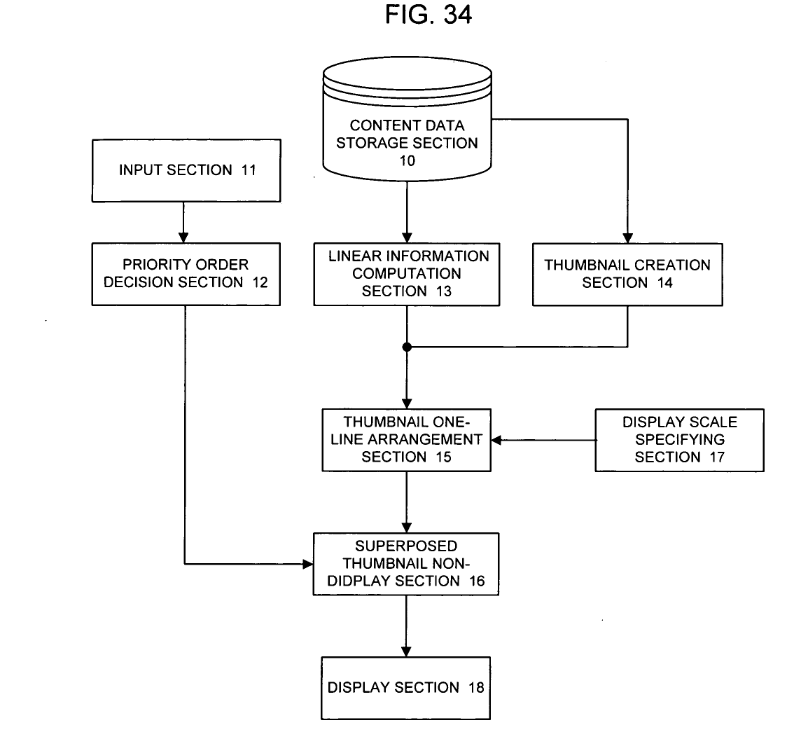

FIG. 34 is a block diagram of the first embodiment of the present invention.

The content display device relating to the first embodiment is configured of a content data storage section 10, an input section 11, a priority order decision section 12, a linear information computation section 13, a thumbnail creation section 14, a thumbnail one-line arrangement section 15, a superposed thumbnail non-display section 16, a display scale specifying section 17, and a display section 18.

The content data storage section 10, which is a record medium into which a content data is stored, is configured of, for example, a hard disc, a RAM, a ROM, a flash memory, etc. Further, the content data, as mentioned above, includes not only an image of the picture etc. and a data such as a telephone number, but also its attribution information. Additionally, in this embodiment, it is assumed that the picture image such as JPEG, and the attribution information of this picture image have been stored into the content data storage section 10.

The input section 11 is an input device such as a mouse and a button.

The priority order decision section 12 is for making a decision as to which priority order is employed for arranging and displaying the content, and the priority order is decided by the user's instruction to the input section 11. For example, with the user's specification, the photographing date, being attribution information of the picture image, can be assumed to be a priority order in some cases, and the priority pre-specified at the time of the photographing can be specified as a priority order in some cases.

The linear information computation section 13 computes the internal coordinate, being linear information, content by content based upon the attribution information of a plurality of the contents. In this embodiment, the internal coordinate of the arrangement position on the screen, being linear information, is decided based upon the photographing time, being attribution information of the content.

The thumbnail creation section 14 creates thumbnails of a plurality of the picture images being input from the content data storage section 10.

The thumbnail one-line arrangement section 15 converts the internal coordinate computed by the linear information computation section 13 into a display-system coordinate based upon a display range that the user has specified in the display range specifying section 17. And, it arranges the thumbnails created by the thumbnail creation section in the display-system coordinate.

The superposed thumbnail non-display section 16 displays the content having a higher priority order, and does not display the content having a lower priority order when the arranged thumbnail companions are superposed upon each other.

The display scale specifying section 17, which is for specifying the display range of the linear coordinate axis being displayed on the screen of the display section 18, decides the display range so that it is, for example, between 2005/10/1 and 2005/10/2 when the linear coordinate axis is a time.

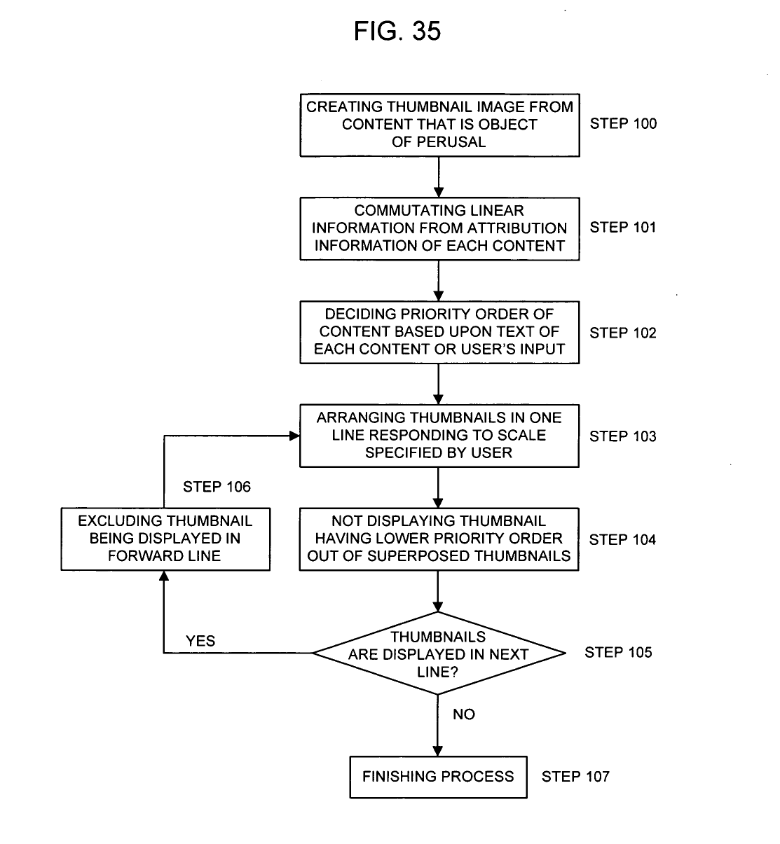

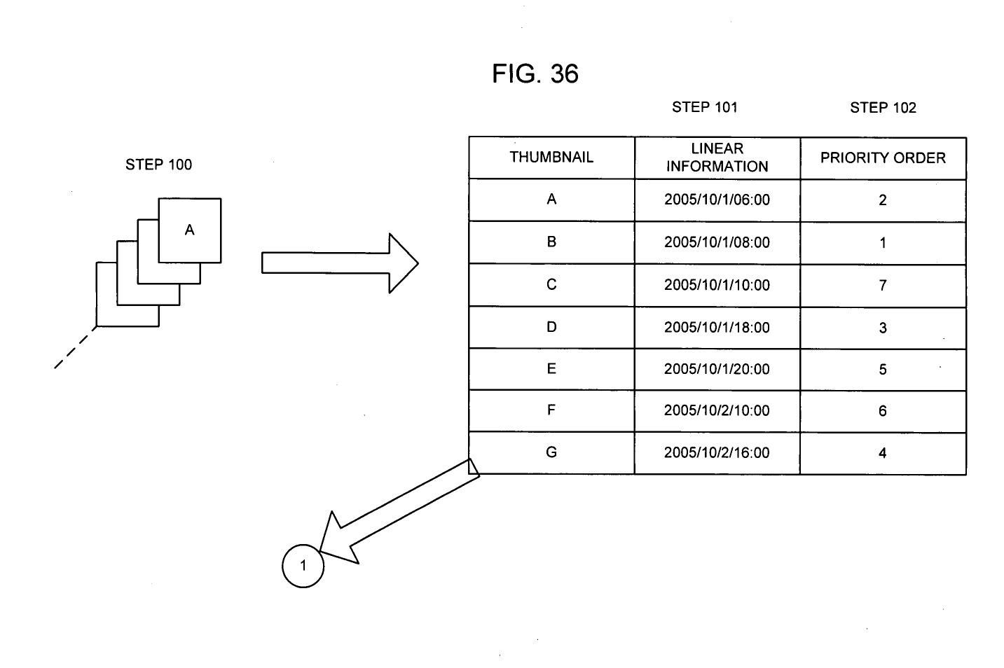

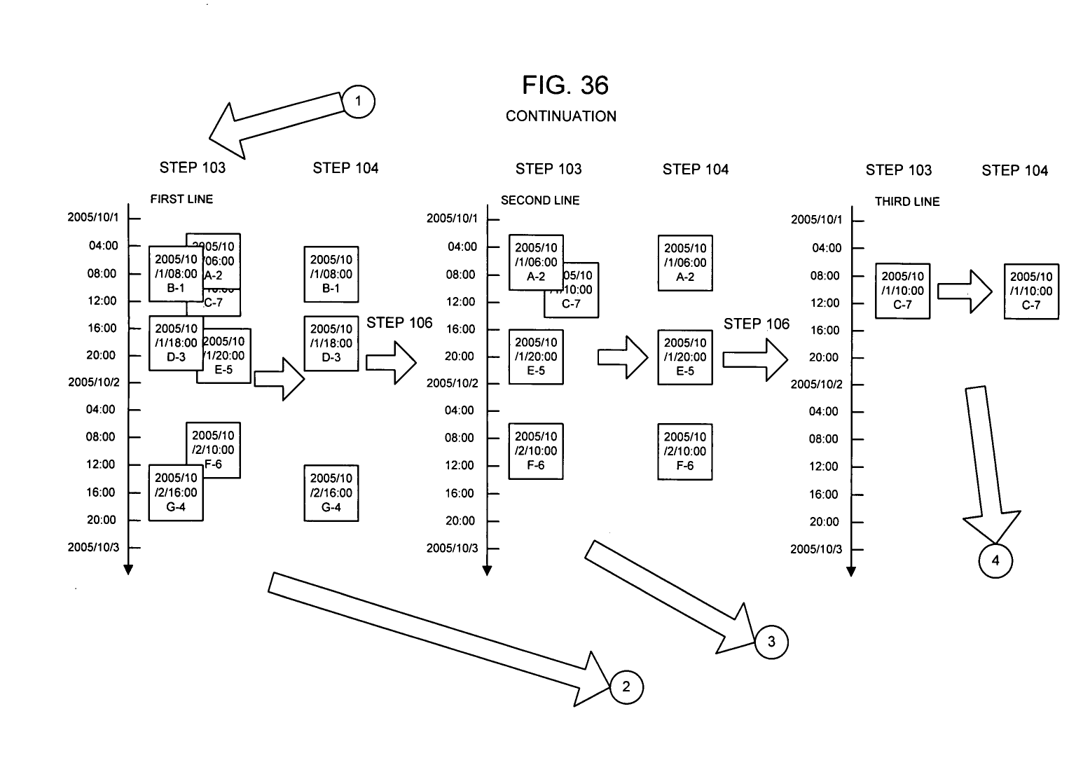

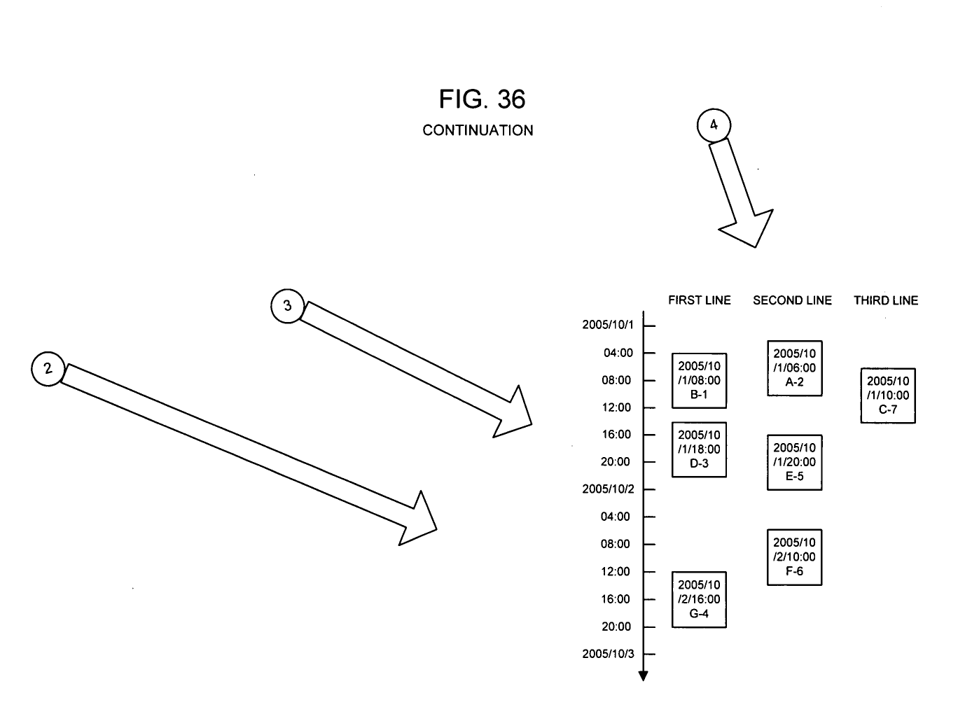

In such a configuration, an operation will be explained by employing a flowchart of FIG. 35 and an explanatory view of FIG. 36. Additionally, the following explanation is made on the assumption that the content is a picture image, and each picture image includes the photographing date and the priority affixed by the user. And, the case will be explained of arranging the thumbnail of the picture image in the corresponding position of the time axis based upon the numerical value information, being linear information computed from the photographing date of the picture.

Further, the numerical value information, being linear information, is a coordinate position on the screen, or the like, and the following explanation is made by replacing the numerical value information, being linear information, with the numerical value of the photographing time for facilitating the understanding. Further, in FIG. 36, the numerical figure in the thumbnail of the picture image signifies the photographing date and the priority order. Further, the case that a range of the time axis of the display screen range is between 2005/10/1 to 2005/10/2, and seven picture images are arranged in the position that corresponds to this time axis will be explained.

At first, the thumbnail creation section 14 creates a thumbnail of a picture image (hereinafter, simply referred to as a thumbnail) from the picture image, being a specified object of perusal (Step 100).

Next, the linear information computation section 13 computes the internal coordinate, being linear information, from the attribution information of each content (Step 101), and in addition hereto, the priority order decision section 12 decides the priority order of each content (Step 102). The view showing the internal coordinates and the priority orders of thumbnails A to C for respective contents is a table of FIG. 36.

Continuously, the thumbnail one-line arrangement section 15 arranges the thumbnails in one line based upon the scale specified by the user (Step 103). And, the superposed thumbnail non-display section 16 does not display the thumbnail having a lower priority order out of the superposed thumbnails (Step 104). The operation of these Step 103 and Step 104 is shown in the first-line view of FIG. 36.

Further, in the case that the thumbnails are displayed in the next line, the operation of the Step 103 and Step 104 is performed again for the thumbnails except for the thumbnails of the contents being displayed in the forward line. The status that the operation of the Step 103 and Step 104 has been performed again for the thumbnails except for the thumbnails B, D, and G being displayed in the first line is shown in the second-line view of FIG. 36, and the status that the operation of the Step 103 and Step 104 has been performed again for the thumbnails except the for thumbnails A, B, D, E, F, and G being displayed in the first line and the second line is shown in the third-line view of FIG. 36. This process is performed as far as the last line.

And, the final display result is shown in a partial view of FIG. 36 illustrating the first line, the second line and the third line in all. In such a manner, the final result becomes identical to that of the first content arrangement/display method explained in the foregoing summary. Needless to say, a process similar to that of the first content arrangement/display method explained in the foregoing summary may be performed.

Further, as explained in the foregoing summary of the invention, in a case where the scale has been changed by the display scale specifying section 17, performing the identical operation again allows the picture image to be again arranged/displayed in a status of the changed scale.

A second embodiment will be explained.

The second embodiment, which is equivalent to the foregoing second content arrangement/display method, assumes a slightly different method.

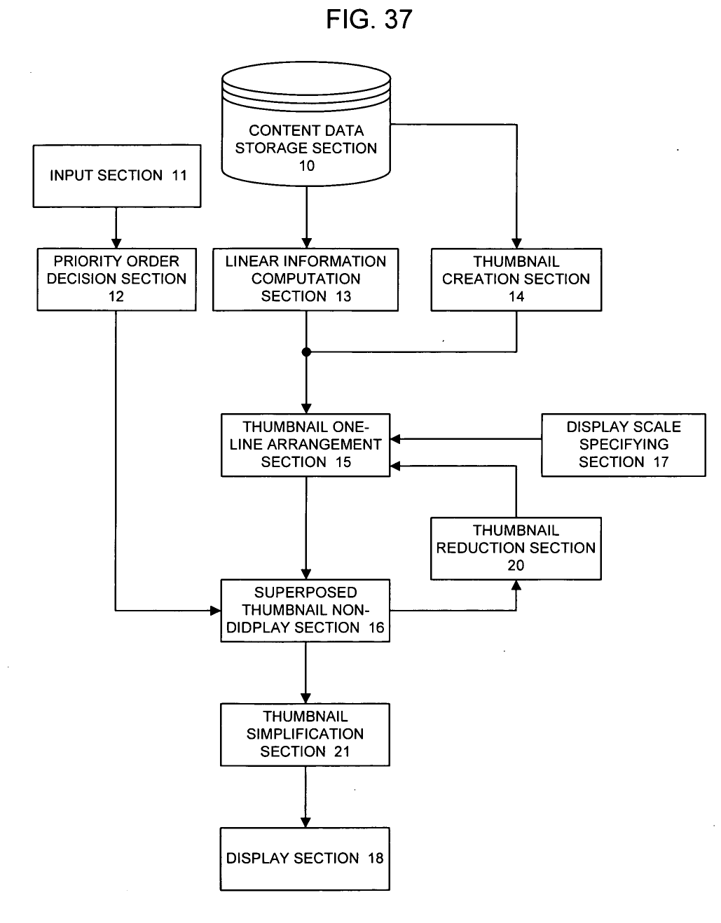

FIG. 37 is a block diagram of the second embodiment of the present invention.

A point in which the second embodiment differs from the first embodiment is that the former is provided with a thumbnail reduction section 20 and a thumbnail simplification section 21 in addition to the configuration of the latter.

The thumbnail reduction section 20 is for reducing the size of the thumbnail to a half of that of the forward-line thumbnail. In this embodiment, it was assumed that the size of the thumbnail was a half of that of the forward-line thumbnail; however the size of the thumbnail is not limited hereto.

The thumbnail simplification section 21 is for allowing only the thumbnail having a largest image, out of the thumbnails displayed in a plurality of the lines, to be displayed, and the other thumbnails not to be displayed.

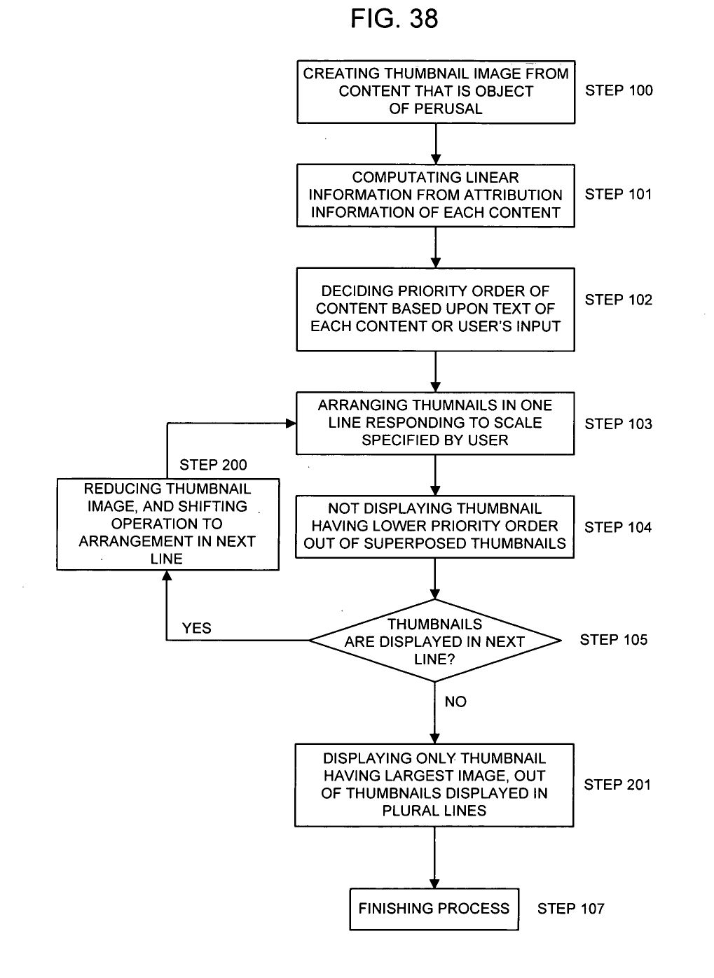

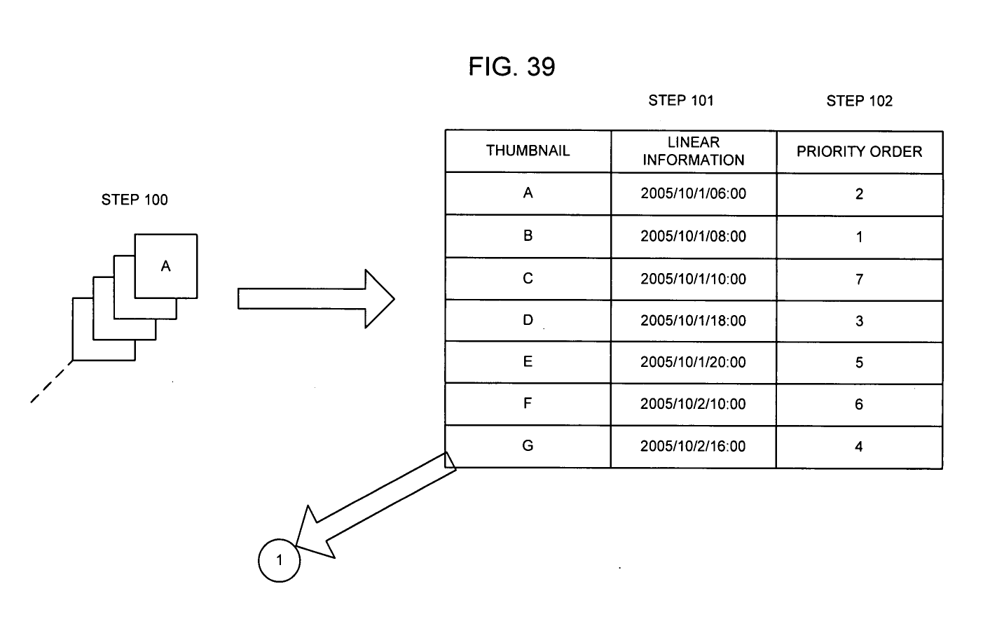

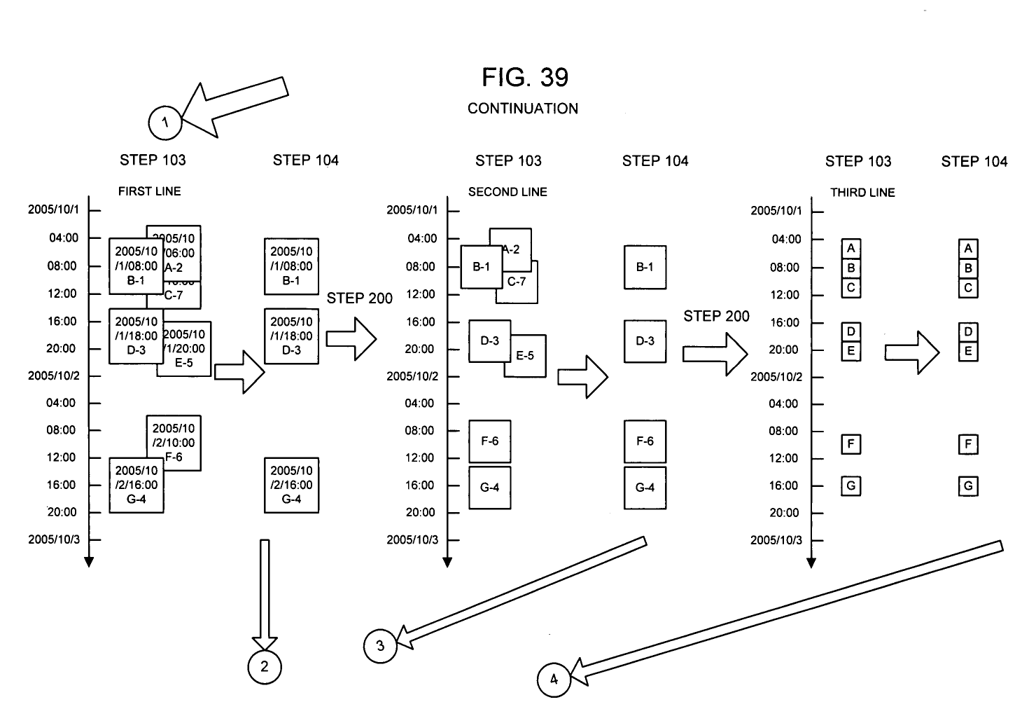

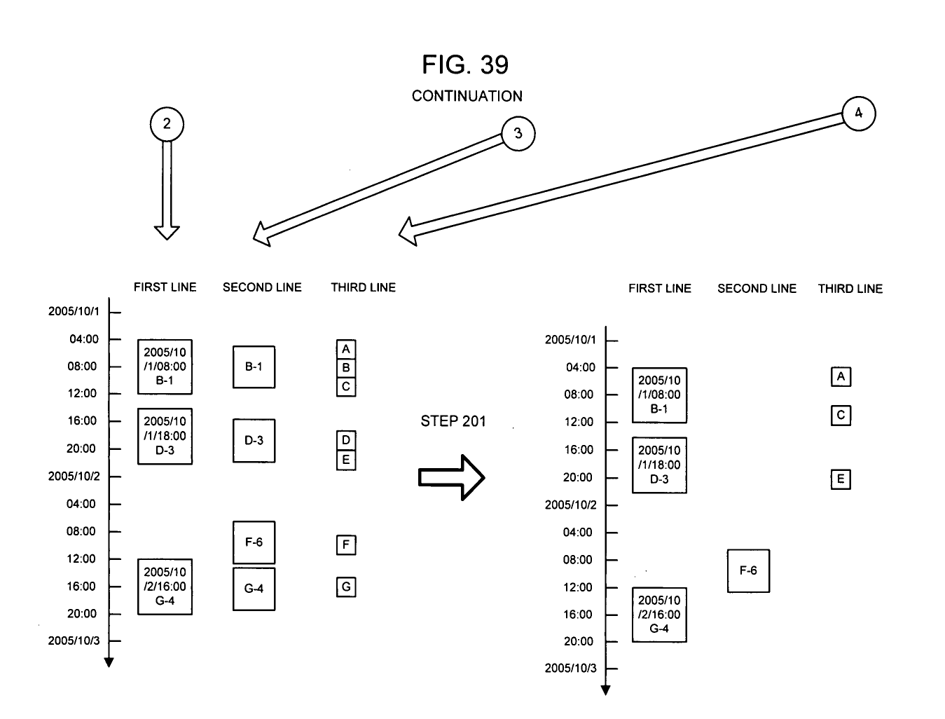

In such a configuration, an operation will be explained by employing a flowchart of FIG. 38 and an explanatory view of FIG. 39. Additionally, an identical step number is affixed to an operation of the second embodiment identical to that of the first embodiment. Further, similarly to the first embodiment, the following explanation is made on the assumption that the content is a picture image, and each picture image includes the photographing date and the priority affixed by the user. And, the case will be explained of arranging the thumbnail of the picture image in the corresponding position of the time axis based upon the numerical value information, being linear information computed from the photographing date of the picture. Additionally, the numerical value information, being linear information, is a coordinate position on the screen, or the like, and the following explanation is made by replacing the numerical value information, being linear information, with the numerical value of the photographing time for facilitating the understanding.

In FIG. 39, the numerical figure in the thumbnail of the picture image signifies the photographing date and the priority order. Additionally, the case that a range of the time axis of the display screen range is between 2005/10/1 to 2005/10/2, and seven picture images are arranged in the position that corresponds to this time axis will be explained.

At first, the thumbnail creation section 14 creates a thumbnail from the content, being a specified object of perusal (Step 100).

Next, the linear information computation section 13 computes the internal coordinate, being linear information, from the attribution information of each content (Step 101), and in addition hereto, the priority order decision section 12 decides the priority order of each content (Step 102). The view showing the internal coordinates and the priority orders of thumbnails A to C for these respective contents is a table of FIG. 36.

Continuously, the thumbnail one-line arrangement section 15 arranges the thumbnails in one line based upon the scale specified by the user (Step 103). And, the superposed thumbnail non-display section 16 does not display the thumbnail having a lower priority order out of the superposed thumbnails (Step 104). The operation of these Step 103 and Step 104 is shown in the first-line view of FIG. 39.

Further, in the case that the thumbnails are displayed in the next line, the thumbnail reduction section 20 reduces the size of the thumbnail into a half, and the thumbnails including the thumbnails being displayed in the forward line are shifted to the next line for arrangement (Step 200), in which the operation of the Step 103 and Step 104 is performed for them again. The status that the operation of the Step 103 and Step 104 has been performed again for the thumbnails of which the sized has been reduced into an half of the size of the thumbnail being displayed in the first line is shown in the second-line view of FIG. 39, and the status that the operation of the Step 103 and Step 104 has been performed again for the thumbnails of which the sized has been reduced into an half of the size of the thumbnail being displayed in the second line is shown in the third-line view.

And, after the process is performed as far as the last line, the thumbnail simplification section 21 displays only the thumbnail having a largest image, out of the thumbnails displayed in a plurality of the lines, and does not displays the other thumbnails (step 201). The left view in the lower side of FIG. 39 signifies the status after performing the process as far as the last line, and the right view signifies the status after performing the process of the thumbnail simplification section 21.

In such a manner, the final result becomes identical to that of the second content arrangement/display method explained in the foregoing summary. Needless to say, a process similar to that of the second content arrangement/display method explained in the foregoing summary may be performed.

Further, as explained in the foregoing summary of the invention, in a case where the scale has been changed by the display scale specifying section 17, performing the identical operation again allows the picture image to be again arranged/displayed in a status of changed scale.

A third embodiment will be explained.

In the foregoing first embodiment and second embodiment, the thumbnail was arranged in the position that corresponded to the time of the time axis or the like based upon the attribution information such as the photographing time, and the thumbnail having a lower priority was not displayed when the thumbnail companions was superposed upon each other. However, in a case where the thumbnail having a lower priority is not displayed due to slight superposition, an efficiency of the display, particularly, in a portable terminal etc. having a narrow screen becomes poor. Thereupon, in the third embodiment, the thumbnail one-line arrangement section 15 is configured so as to shift the arrangement location of the thumbnail having a lower priority for arrangement in a case where the thumbnail companions have been superposed upon each other in a predetermined range, thereby enabling the thumbnail as well having a lower priority to be displayed.

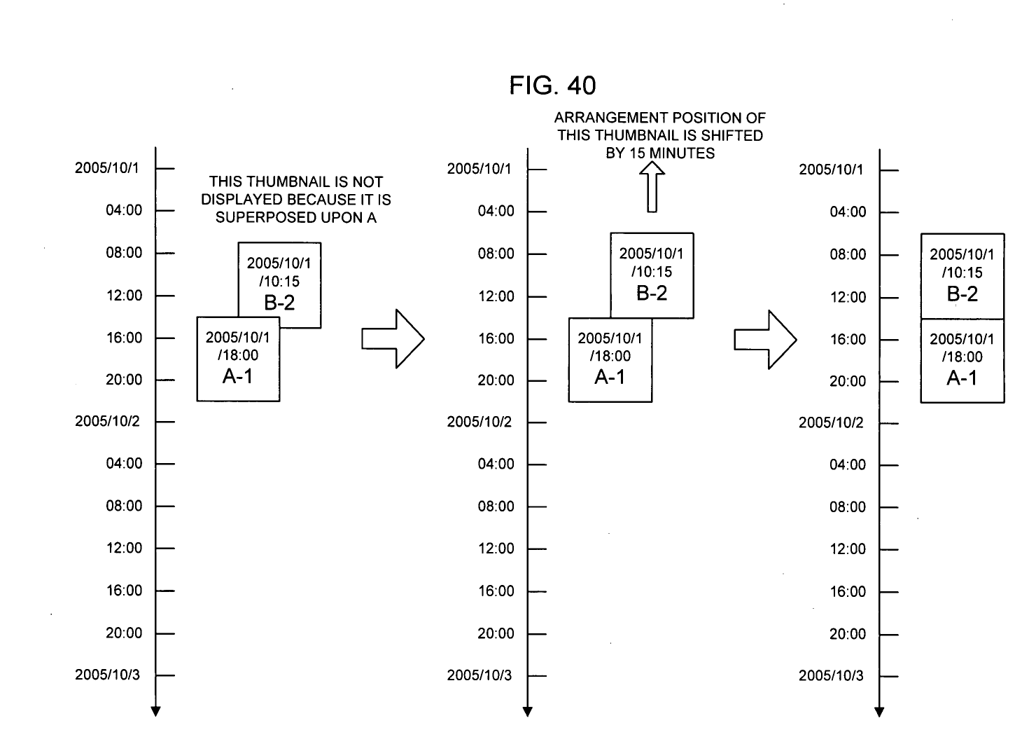

FIG. 40 is a view for explaining the third embodiment.

As shown in FIG. 40, a thumbnail A is a thumbnail of which the priority order and the photographing date are a first place and 2005/10/1/18:00, respectively, and a thumbnail B is a thumbnail of which the priority order and the photographing date are a second place and 2005/10/1/10:15, respectively, and arranging them in the positions that correspond to the times on the time axis causes them to be superposed upon each other, so the thumbnail B is not displayed in the foregoing first embodiment and second embodiment.

However, in the third embodiment, the thumbnail one-line arrangement section 15, in a case where the thumbnail A and the thumbnail B are superposed upon each other in a predetermined range, shifts the location in which the thumbnail B is arranged, thereby enabling the thumbnail B as well to be displayed. In FIG. 40, the thumbnail one-line arrangement section 15 shifts the arrangement location of the thumbnail B upward by 15 minutes so that it is not superposed upon the thumbnail A, thereby enabling the thumbnail B as well to be arranged in a line identical to the line in which the thumbnail A is arranged. Additionally, the allowable superposition range is pre-set to the thumbnail one-line arrangement section 15 without departing from a sprit and scope of the present invention.

A fourth embodiment will be explained.

In the foregoing embodiments, an example of the picture image as one kind of the content was explained; however the present invention is applicable to plural kinds of the contents each of which is different from the other. Thereupon, in the fourth embodiment, an example of mixing and displaying plural kinds of the contents will be explained.

In the fourth embodiment, as an example of mixing and displaying plural kinds of the contents, the case of mixing and displaying a data of a telephone directory having a name and a telephone number as a pair, and a data of a label that becomes a clue at the time of juxtaposing the data of the telephone directory in an order of a, i, u, e, o will be explained.

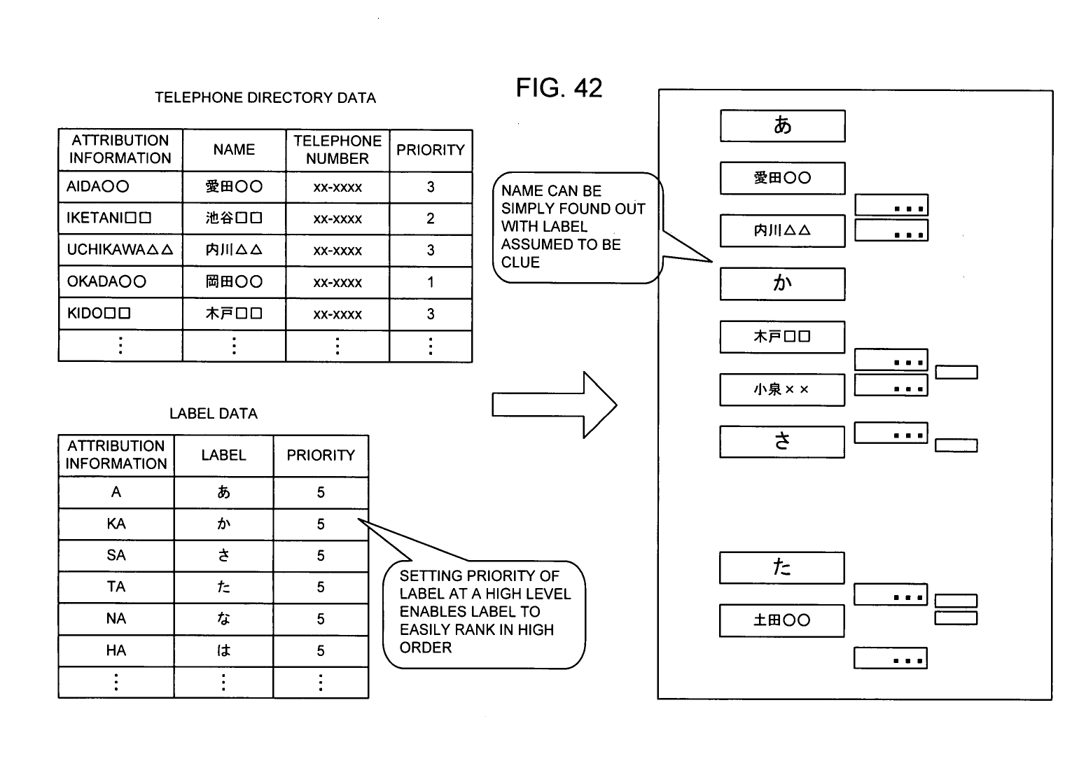

FIG. 42 is a view for explaining the fourth embodiment.

As shown in FIG. 42, in the telephone directory data, each of a name, a telephone number, katakana information, which is attribution information that becomes a reference at the moment of arranging the name and the telephone number, and a priority for arrangement/display is caused to corresponded to the other. Further, in the label data, each of a label of [symbol] or the like, katakana information, which is attribution information that becomes a reference at the moment of arranging its label, and a priority for arrangement/display is caused to correspond to the other.

Mixing these telephone directory data and label data, and performing the foregoing arrangement/display process of the present invention for them causes the labels to be arranged/displayed in the first line, and the name and the telephone number to be arranged and displayed between the labels because “5” having a high priority has been affixed to all of the labels. In such a manner, setting the priority of the label at a high level causes the label to be easily displayed in the high order. As a result, the name can be found out in a simple manner with the label assumed to be a clue.

Further, as mentioned above, not limiting the content to one kind, but mixing plural kinds of the contents and affixing an appropriate priority hereto makes it possible to simultaneously arrange/display plural kinds of the contents.

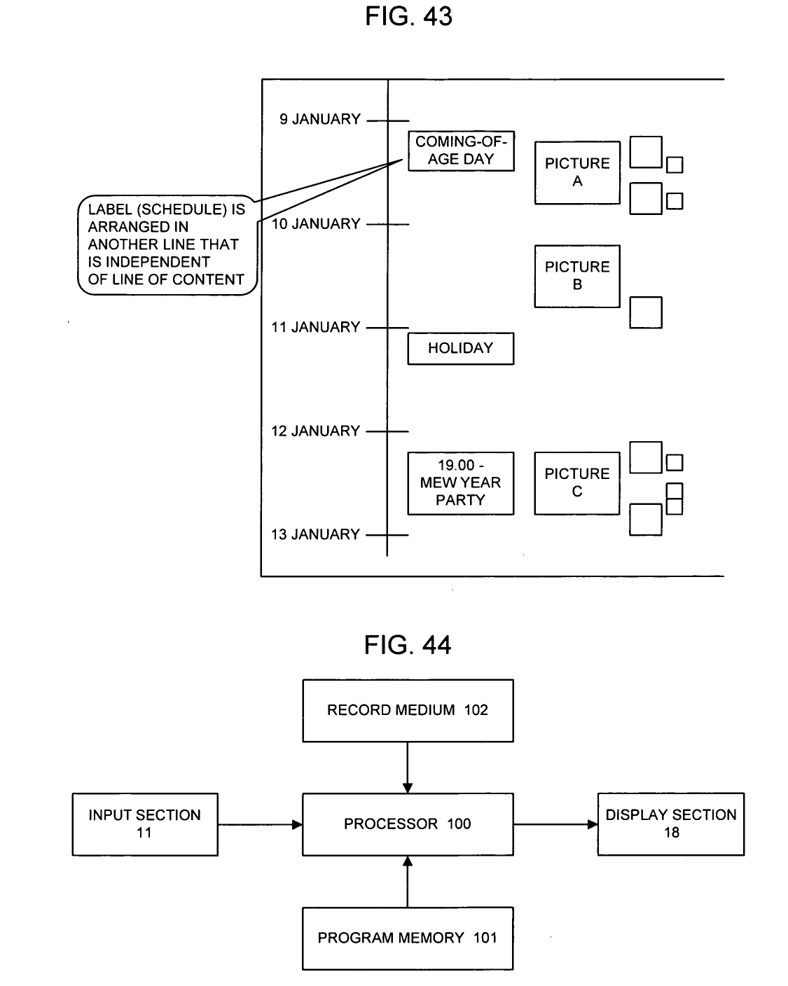

Further, a configuration may be made so that plural kinds of the contents are arranged/displayed for each kind of the content without being mixed and are simultaneously displayed on the identical screen. For example, a configuration may be made so that an arrangement process is separately performed for the label and the picture image, and the label (schedule), which is arranged in another line that is independent of the line of the content (picture image), and the picture image are displayed on the screen, as shown in FIG. 43.

A fifth embodiment will be explained.

In the foregoing first embodiment and second embodiment, whenever the user performed an operation of changing the display scale with the display scale specifying section 17, the thumbnails were arranged responding to its scale. Whenever the user performs an operation of changing the scale, he/her has to wait until its operation is reflected into the thumbnail arrangement on the screen because the arrangement of the thumbnails needs a constant time. Thereupon, the fifth embodiment is characterized in reducing a user's wait time during the operation by pre-deciding the scale that is selectable by the user, and pre-computing the arrangement of the thumbnail at its all scales in the first place.

Further, in the present invention, it seems that when the user enlarges the scale, the space interval between the first-line thumbnails is enlarged, and the thumbnails migrate to the enlarged space interval of the first line one after another from the second line and the line after it. Contrarily, when the user reduces the scale, the thumbnail having a lower importance degree is pushed out to the second line and the line after it because the space interval between the first-line thumbnails is narrowed, and the thumbnails are superposed upon each other. In such a manner, one of the large characteristics is that an enlargement/reduction operation and a left/right migration of the thumbnail between the lines are linked to each other.

However, when the thumbnails are arranged one after another responding to the user's change in the scale, as is often the case, this unified movement gets out of order. For example, FIG. 46 signifies the situation in which enlarging the scale causes the images having a second-place priority order and the image having a fourth-place priority order arranged in the second line before enlargement to rank upward to the first line, and the image having a fifth-place priority order to return to the second line in such a manner of being pushed out by these images. It lacks a unity feeling and is not desirable that both of the thumbnail that moves to the right and the thumbnail that moves to the left exist for one operation. In this example, if it is known in advance that the enlargement the scale causes the thumbnail having a fifth-place priority order to be pushed out, this thumbnail is not arranged in the first line even in a status prior to enlargement of the scale, thereby enabling disunity of the movement to be prevented.

In this embodiment, setting the limiting condition at the moment of previously computing the arrangement of the thumbnail in such a manner enables the unified migration of the thumbnail having no disorder to be realized.

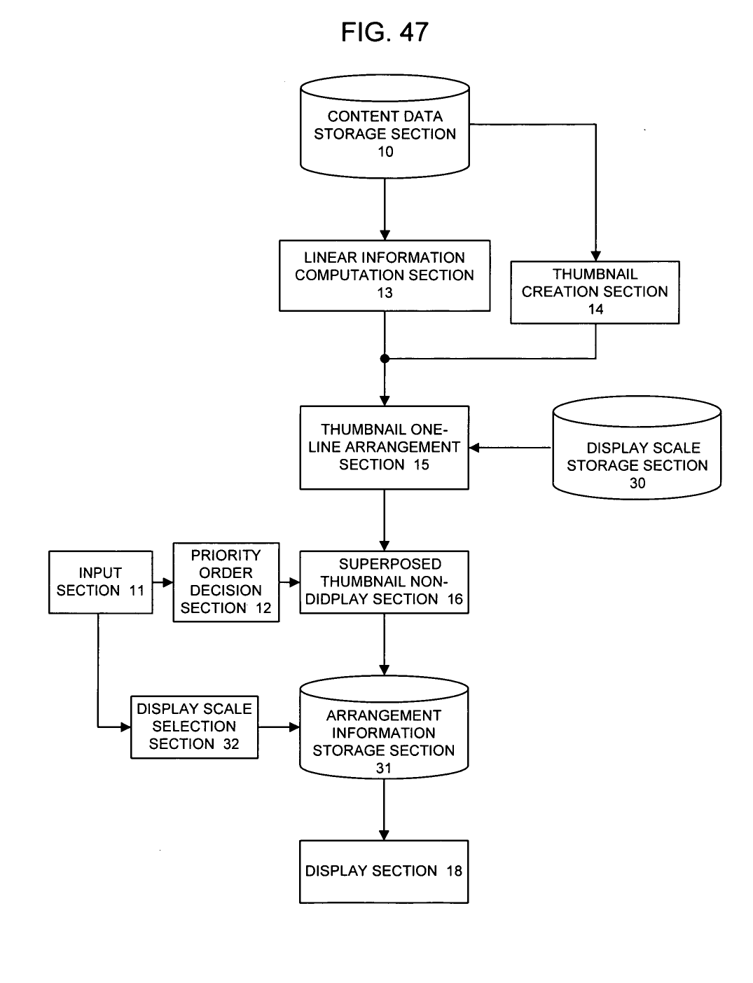

FIG. 47 is a block diagram of the fifth embodiment of the present invention.

A point in which the fifth embodiment differs from the first embodiment is that the former is provided with a display scale storage section 30, an arrangement information storage section 31, and a display scale selection section 32 in addition to the configuration of the latter.

The display scale storage section 30 previously stores the scales that are selectable by the user. As an example, in the case the thumbnails are arranged in a unit of the time, a configuration may be made so that pre-storing a range of the time, which is displayed on one screen, in a unit of the time that is easy to understand, for example, a portion of one year, a portion of one month, a portion of one day, and a portion of one hour enables the user to select one of them. Further, As another example, a configuration may be made so that, by preparing a constant number of the scales obtained by enlarging the scale by a factor of two, four, eight, . . . , for example, the scale having a portion of one year, which is a most reduced scale, that is, a scale where many times are accommodated, the scale having a portion of six months, the scale having a portion of three months, a portion of one month and a half, . . . , it is possible to enlarge the scale by a factor of two when the user desires to view the thumbnails in much detail, and to reduce the scale into a half when he/her desires to view a wider scope of the thumbnails.

The arrangement information storage section 31 pre-stores the information of the thumbnail arrangement position decided by the thumbnail one-line arrangement section 15, and the information of the thumbnail arrangement position decided by the superposed thumbnail non-display section 16, respectively, at each scale stored in the display scale storage section 30.

The display scale selection section 32, via the input section 11, makes a selection as to which thumbnail arrangement information, out of the thumbnail arrangement information at each scale stored in the arrangement information storage section 31, is displayed on the display section 18 by the user. At that moment, as mentioned previously, a configuration is made so that no disunity in the migration of the thumbnail occurs when the scale is changed.

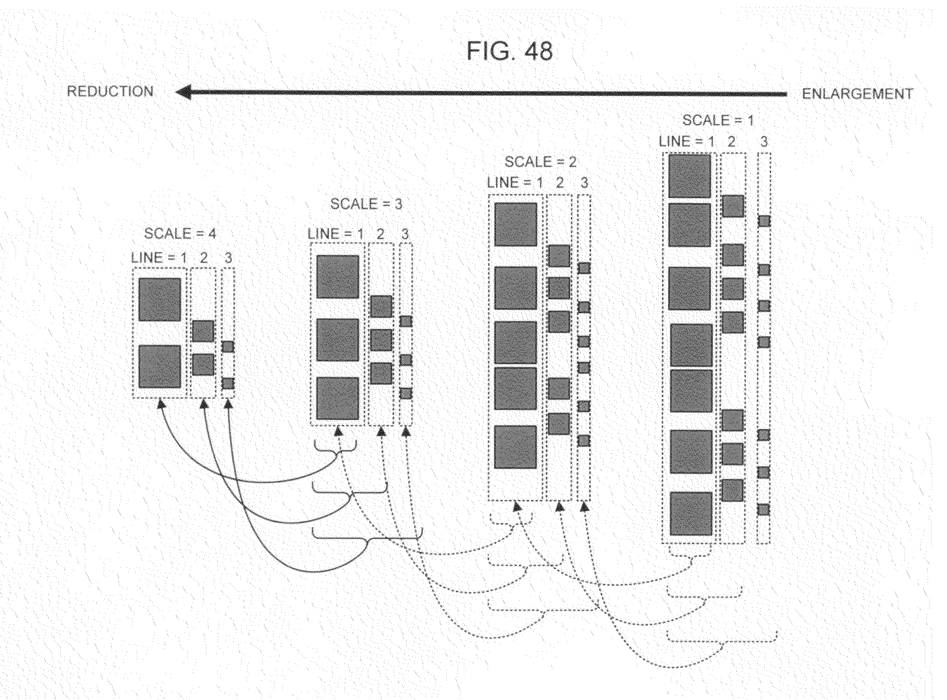

Its specific method will be explained by employing FIG. 48.

A distinction is made by assuming the scales preserved in the display scale storage section 30 to be SCALE=1, 2, 3 . . . , respectively, in the descending order of the enlargement, that is, in the descending order of the number of the arranged thumbnails, and by affixing LINE=1, 2, 3 . . . to the lines in which the thumbnails are arranged, respectively, in the descending order of the importance that the thumbnail has.

The thumbnail arrangement is made in the order of SCALE=1, SCALE=2, SCALE=3, . . . , and with SCALE=1, the thumbnails are arranged similarly to the case of the embodiment 1, that is, there is no limit to the thumbnail; however, with SCALE=2 and thereafter, the thumbnail, which becomes a candidate that is arranged, is limited to the thumbnail arranged in the left lines including the above line at the scale just ahead. That is, only the thumbnail arranged at SCALE=S−1 and in LINE=1 . . . L is employed as the thumbnail being arranged at SCALE=S and in LINE=L.

The limitation above makes it possible to realize the unified movement such that when the scale is reduced, the thumbnail migrates only in a direction that the LINE number augments (in the figure, left to right), and when the scale is enlarged, contrarily, the thumbnail migrates only to the left from the right.

Next, a sixth embodiment will be explained.

The foregoing fifth embodiment was adapted so that pre-computing the arrangement of the thumbnail at a predetermined scale eliminated a necessity for computing the arrangement whenever the user performed an operation of changing the scale. However, when the user has changed an importance degree of one part of the content being arranged, or has added a new content, the thumbnail arrangements at all scales have to be computed newly for each time. Thereupon, the sixth embodiment is adapted so that even when the user has performed the processes such as a change, a deletion, an addition for one part of the content being displayed, the arrangement position can be updated with the minimum computation quantity.

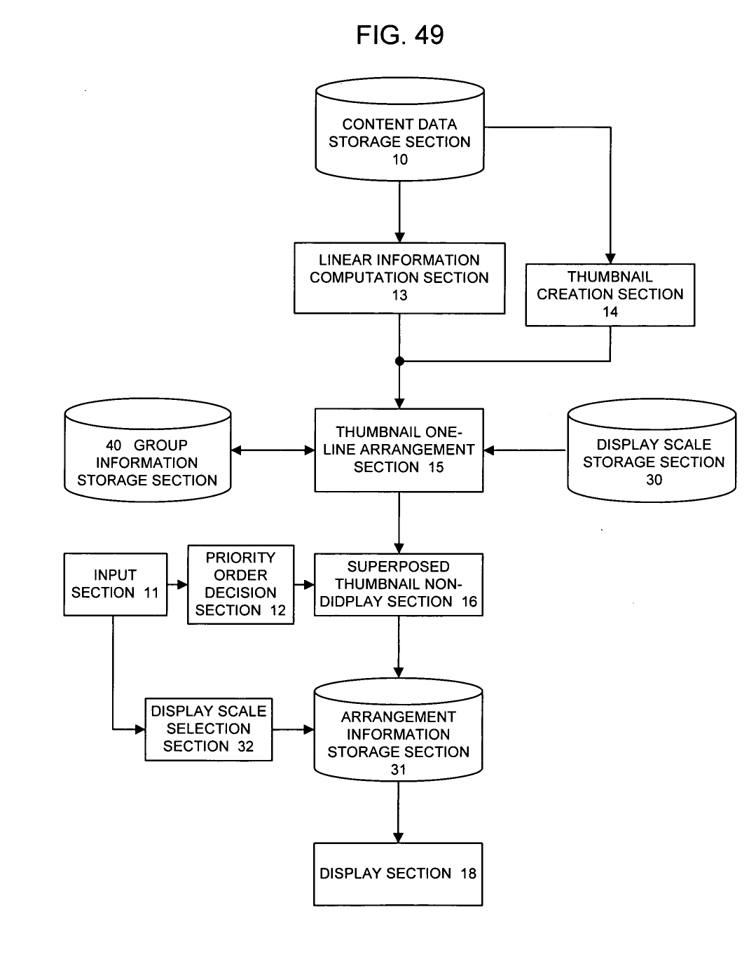

The sixth embodiment will be explained by employing FIG. 49. The sixth embodiment assumes a configuration in which a group information storage section 40 has been added to that of the fifth embodiment.

The group information storage section 40 stores information obtained by grouping the thumbnail companions, which mutually exert an influence upon the arrangement, at each scale stored in the display scale storage section 30. When the user performs an operation of the change/addition for the content, and a necessity for re-computing the arrangement arises, the thumbnail one-line arrangement section 15 retrieves the group to which the added/changed content belongs from the group information storage section 40, and re-computes only the thumbnail position of the content being included in its group, thereby making it possible to update the arrangement position with the computation quantity fewer than the computation quantity necessary for newly computing all of the arrangement positions.

As a method in which the group information storage section 40 groups the content companions, the content companions, which are superposed in the case that all of the contents, of which the thumbnail size is largest, have been arranged on the coordinate axis, may be grouped at respective scales. Further, like the case of third embodiment, the thumbnail companions, which are superposed in the case that the thumbnail has been arranged by making a shift to the utmost, have to be grouped because permitting a constant quantity of “shift” at the moment of arranging the thumbnail, causes the range in which the thumbnail companions exert an influence upon each other to expand to that extent.

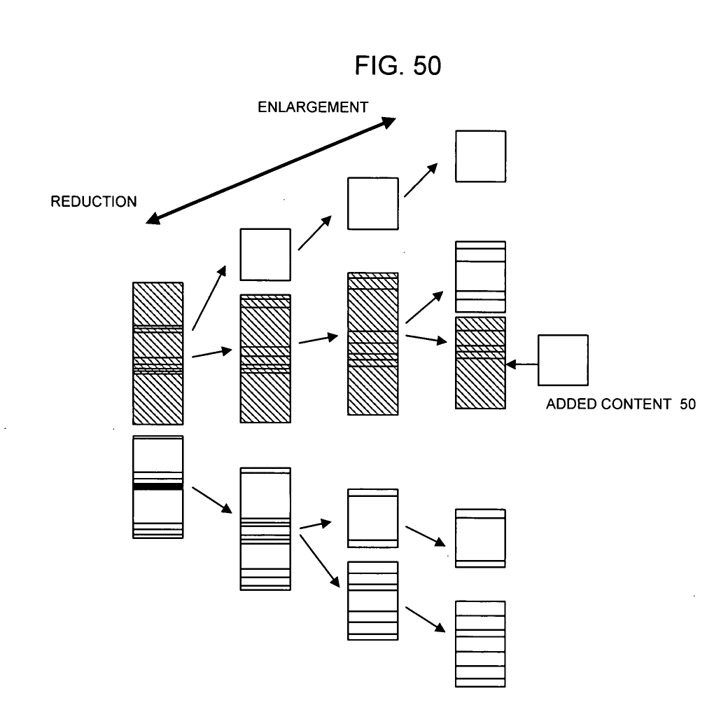

FIG. 50 is a view illustrating the situation of grouping the thumbnail companions in the case of having arranged all of the thumbnails in one line at each of four scales as an example.

One block of the thumbnails superposedly arranged is one group. The group can be expressed with a tree structure that is divided more finely as the scale is enlarged.

Further, as an example, the group requiring that the arrangement position be re-computed when a new content 50 (thumbnail) is added is shown with an oblique line. In a case where the group information has been stored as a tree structure, tracing the tree structure from a parent to a child in the descending order of the enlargement of the scale makes it possible to easily search for the thumbnail that requires the re-computation at each scale because as shown in the fifth embodiment, the computation of the arrangement is operated in the descending order of the enlargement of the scale.

Further, it follows that the user recognizes the grouped image (thumbnail) companions as one aggregation of the images (thumbnails) arranged closely to each other also when they are actually displayed.

In such a manner, the present invention is characterized in that arranging the thumbnail on the linear axis by its feature quantity makes it possible to automatically display the related thumbnails closely to each other, and to grasped them as an aggregation, whereas this distance between the aggregation companions is not so important in many case, and contrarily, as is often the case, the space interval between the groups is widened, and sightability is disturbed due to the arrangement that is made faithfully to the linear information.

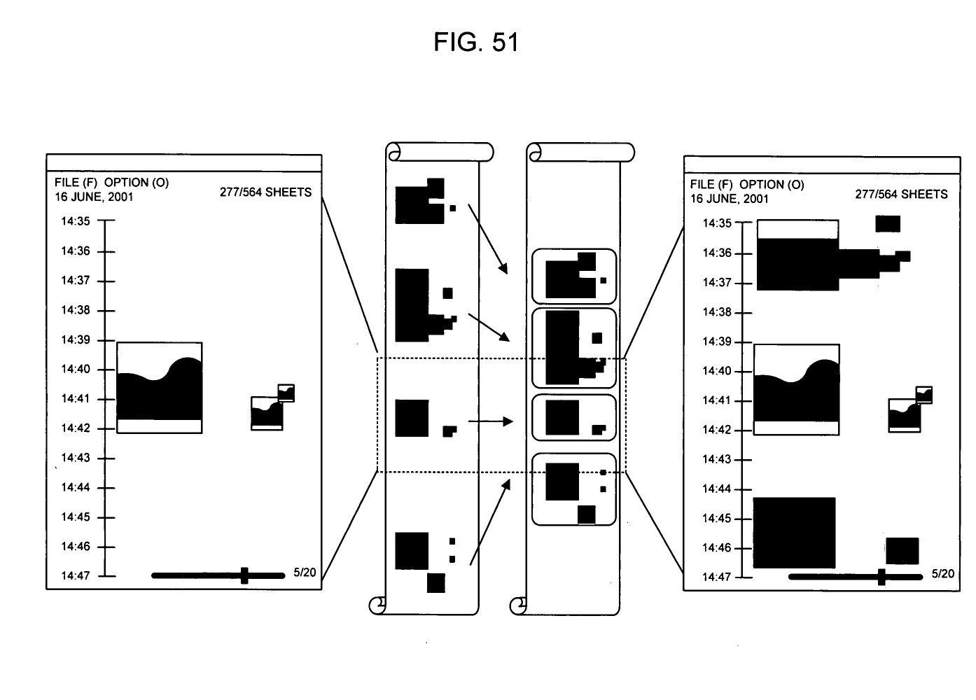

Thereupon, as shown in FIG. 51, when the space interval between the group companions is widened by a constant or more at the moment of the display, its space interval is narrowed for display, thereby making it possible to increase the number of the contents being displayed on one screen, and to enhance the sightability without disturbing expression of relativity of the thumbnail companions.

A seventh embodiment will be explained.

The content display device of the present invention, as apparent from the above explanation, can be configured of hardware, and also can realized with a computer program.

FIG. 44 is a general block configuration diagram of the information processing system in which the content display device of the present invention has been implemented.

The information processing system shown in FIG. 44 is comprised of a processor 100, a program memory 101, a record medium 102, an input section 11, and a display section 18. Additionally, the input section 11, similarly to the case of the foregoing embodiments, is a key button, a mouse, or the like.

The record medium 102, which plays a role of the content data storage section 10, the display scale storage section 30, the arrangement information storage section 31, and the group information storage section 40, could be a separate record medium, and could be a record region that is comprised of the identical record medium. As a record medium, a magnetic record medium such as a RAM and a hard disc can be employed.

The program memory 101 has a program stored therein for causing the processor 100 to execute the process of each of the foregoing priority order decision section 12, linear information computation section 13, thumbnail creation section 14, thumbnail one-line arrangement section 15, superposed thumbnail non-display section 16, display scale specifying section 17, thumbnail reduction section 20, thumbnail simplification section 21, and display scale selection section 32, and the processor 100 operates under this program. And, its result is displayed on the display section 18.

In such a manner, the content display device can be realized also with the computer program.

Additionally, there is no necessity for operating all of the priority order decision section 12, the linear information computation section 13, the thumbnail creation section 14, the thumbnail one-line arrangement section 15, the superposed thumbnail non-display section 16, the display scale specifying section 17, the thumbnail reduction section 20, and the thumbnail simplification section 21 with the program, and one part thereof may be configured with hardware.

1. A content display method of, based upon predetermined attribution information of a content, arranging and displaying the content on a screen, comprising:
deciding a priority order that is employed at the moment of arranging each content on the screen; and
arranging the content in a corresponding position on the screen based upon said attribution information, and when the contents are superposedly displayed, displaying the content having a higher priority order and not displaying the content having a lower priority order.

2. A content display method according to claim 1, further comprising arranging each content across a plurality of lines.

3. A content display method according to claim 2, further comprising, when each content is arranged across the plurality of the lines, reducing a display of the content being arranged in a next line as compared with a display of the content arranged in a forward line.

4. A content display method according to claim 2, further comprising, when each content is arranged across the plurality of the lines, arranging the content, which is not displayed in a forward line, in a position that corresponds to a linear axis based upon said attribution information, and when the contents are superposedly displayed, displaying the content having a higher priority order and not displaying the content having a lower priority order.

5. A content display method according to claim 3, further comprising, when each content is arranged across the plurality of the lines, arranging all of the contents including the content being displayed in the forward line in a position that corresponds to a linear axis based upon said attribution information, and when the contents are superposedly displayed, displaying the content having a higher priority order and not displaying the content having a lower priority order and the content as well displayed in the forward line.

6. A content display method according to claim 2, further comprising, when each content is arranged across the plurality of the lines, arranging all of the contents in a position that corresponds to a linear axis based upon said attribution information for each line, and when the contents are superposedly displayed, displaying the content having a higher priority order and not displaying the content having a lower priority order and the content as well being displayed in a forward line

7. A content display method according to claim 1, further comprising, when the contents are superposedly displayed in a predetermined range, adjusting a position in which the content is arranged so that the contents are not superposedly displayed.

8. A content display method according to claim 1, further comprising, when a caliber range of a linear axis has been changed, performing a process of an arrangement again.

9. A content display method according to claim 1, further comprising previously computing and storing all of the arrangement positions of the contents at a predetermined scale of a caliber.

10. A content display method according to claim 9, further comprising, at the moment of computing all of the arrangement positions of the contents at the predetermined scale of the caliber, setting a limit so that a migration direction of the content, which migrates when the scale has been changed, is unified.

11. A content display method according to claim 9, further comprising previously grouping and storing content companions that mutually exert an influence upon the arrangement position at the predetermined scale of the caliber, and when one part of the content being displayed has been changed, deleted, or added, re-computing the arrangement position only in a range in which an arrangement of the above content is influenced.

12. A content display method according to claim 11, further comprising, when the grouped content companions are displayed at a space interval of a constant or more, narrowing its space interval and displaying the content.

13. A content display device for, based upon predetermined attribution information of a content, arranging and displaying the content on a screen, comprising:
a priority order decision means for deciding a priority order that is employed at the moment of arranging each content on the screen; and
an image arrangement displaying means for arranging the content in a corresponding position on the screen based upon said attribution information, and when the contents are superposedly displayed, displaying the content having a higher priority order and not displaying the content having a lower priority order.

14. A content display device according to claim 13, wherein said image arrangement displaying means is configured to arrange each content across a plurality of lines.

15. A content display device according to claim 14, wherein said image arrangement displaying means is configured so that when each content is arranged across the plurality of the lines, a display of the content being arranged in a next line is reduced as compared with a display of the content being arranged in a forward line.

16. A content display device according to claim 14, wherein said image arrangement displaying means is configured so that when each content is arranged across the plurality of the lines, the content, which is not displayed in a forward line is arranged in a position that corresponds to a linear axis based upon said attribution information, and when the contents are superposedly displayed, the content having a higher priority order is displayed, and the content having a lower priority order is not displayed.

17. A content display device according to claim 14, wherein said image arrangement displaying means is configured so that when each content is arranged across the plurality of the lines, the contents including the content being displayed in the forward line are arranged in a position that corresponds to a linear axis based upon said attribution information, and when the contents are superposedly displayed, the content having a higher priority order is displayed, and the content having a lower priority order and the content as well being displayed in a forward line are not displayed

18. A content display device according to claim 14, wherein said image arrangement displaying means is configured so that when each content is arranged across the plurality of the lines, all of the contents are arranged in a position that corresponds to a linear axis based upon said attribution information for each line, and when the contents are superposedly displayed, the content having a higher priority order is displayed, and the content having the lower priority order and the content as well being displayed in the forward line are not displayed.

19. A content display device according to claim 13, wherein said image arrangement displaying means is configured so that when the contents are superposedly displayed in a predetermined range, a position in which the content is arranged is adjusted so that the contents are not superposedly displayed.

20. A content display device according to claim 13, wherein said image arrangement displaying means is configured to perform a process of an arrangement again when a caliber range of a linear axis has been changed.

21. A content display device according to claim 13, wherein said image arrangement displaying means previously computes and stores all of the arrangement positions of the contents at a predetermined scale of a caliber.

22. A content display device according to claim 21, wherein at the moment of computing all of the arrangement positions of the contents at the predetermined scale of the caliber, said image arrangement displaying means sets a limit so that a migration direction of the content, which migrates when the scale is changed, is unified.

23. A content display device according to claim 21, wherein said image arrangement displaying means previously groups and stores content companions that mutually exert an influence upon the arrangement position at the predetermine scale of the caliber, and when one part of the content being displayed has been changed, deleted, or added, re-computes the arrangement position only in a range in which an arrangement of the above content is influenced.

24. A content display device according to claim 23, wherein when the grouped content companions are displayed at an space interval of a constant or more, said image arrangement displaying means narrows its space interval and displaying the content.

25. A computer readable medium storing a program of an information processing device for, based upon predetermined attribution information of a content, arranging and displaying the content on a screen, wherein when executed by the information processing device, causing the information processing device to perform:
a priority order decision process of deciding a priority order that is employed at the moment of arranging each content on the screen; and
a content arrangement display process of arranging the content in a corresponding position on the screen based upon said attribution information, and when the contents are superposedly displayed, displaying the content having a higher priority order and not displaying the content having a lower priority order.

26. A computer readable medium according to claim 25, further comprising: performing said content arrangement display process across a plurality of lines.

27. A computer readable medium according to claim 26, wherein the content arrangement display process includes a process of, when said content arrangement display process is performed across the plurality of the lines, reducing a display of the content as compared with a display of the content arranged in a forward line.

28. A computer readable medium according to claim 26, wherein the content arrangement display process is a process of, when said content arrangement display process is performed across the plurality of the lines, arranging the content, which is not displayed in a forward line, in a position that corresponds to a linear axis based upon said attribution information, and when the contents are superposedly displayed, displaying the content having a higher priority order and not displaying the content having a lower priority order.

29. A computer readable medium according to claim 26, wherein, the content arrangement display process is a process of, when said content arrangement display process is performed across the plurality of the lines, arranging all of the contents including the content being displayed in the forward line in a position that corresponds to a linear axis based upon said attribution information, and when the contents are superposedly displayed, displaying the content having a higher priority order and not displaying the content having a lower priority order and the content as well being arranged in a forward line.

30. A computer readable medium according to claim 26, wherein the content arrangement display process is a process of, when said content arrangement display process is performed across the plurality of the lines, arranging all of the contents in a position that corresponds to a linear axis based upon said attribution information for each line, and when the contents are superposedly displayed, displaying the content having a higher priority order and not displaying the content having the lower priority order and the content as well being displayed in the forward line.

31. A computer readable medium according to claim 25, wherein said content arrangement display process includes a process of, when the contents are superposedly displayed in a predetermined range, adjusting a position in which the content is arranged so that the contents are not superposedly displayed.

32. A computer readable medium according to claim 25, wherein, when a caliber range of a linear axis has been changed, performing said content arrangement display process again.

33. A computer readable medium according to claim 25, wherein said content arrangement display process is a process of previously computing and storing all of the arrangement positions of the contents at a predetermined scale of a caliber.

34. A computer readable medium according to claim 33, wherein said content arrangement display process is a process of, at the moment of computing all of the arrangement positions of the contents at the predetermined scale of the caliber, setting a limit so that a migration direction of the content, which migrates when the scale has been changed, is unified.

35. A computer readable medium according to claim 33, wherein said content arrangement display process is a process of previously grouping and storing content companions that mutually exert an influence upon the arrangement position at the predetermined scale of the caliber, and when one part of the content being displayed has been changed, deleted, or added, re-computing the arrangement position only in a range in which an arrangement of the above content is influenced.

36. A computer readable medium according to claim 35, wherein said content arrangement display process is a process of, when the grouped content companions are displayed at an space interval of a constant or more, narrowing its space interval and displaying the content.
